(19) United States
(12) Patent Application Publication
(10) Pub. No.: US 2020/0126367 A1
(43) Pub. Date: Apr. 23, 2020

(54) VARIABLE SYMBOL SETS FOR VARIABLE WIN FREQUENCY GAMING

(71) Applicant: ADP GAUSELMANN GMBH, Espelkamp (DE)

(72) Inventor: Wojciech Bosak, Wien (AT)

(21) Appl. No.: 16/719,893

(22) Filed: Dec. 18, 2019

Related U.S. Application Data
(63) Continuation-in-part of application No. 16/290,467, filed on Mar. 1, 2019.
Application No. 16/290,467 is a continuation of application No. 15/942,370, filed on Mar. 30, 2018, now Pat. No. 10,223,873.

(51) Int. Cl. G07F 17/34; G07F 17/32

(52) U.S. Cl. CPC G07F 17/34; G07F 17/323; G07F 17/3267; G07F 17/3211; G07F 17/3209

(57) ABSTRACT

A gaming system and method are disclosed as having different symbol sets associated with different win rates that are combined to create variable win frequency gaming. The gaming system may include a plurality of reel strip sets. Each reel strip set may include a plurality of reel strips. Each reel strip set may have a different probability of achieving a predetermined outcome. After a predetermined outcome on the gaming system is generated, the gaming system may select a different reel strip set having a different probability of achieving a predetermined outcome. In some implementations, the selected new reel strip set may have a higher probability of achieving a predetermined outcome than the current reel strip set. The higher probability of achieving a predetermined outcome increases the chance that the subsequently played game(s) will also result in achieving a predetermined outcome for the player.

### CROSS-REFERENCE TO RELATED APPLICATIONS

The present application claims priority under 35 U.S.C. § 120 as a Continuation-in-Part of prior U.S. patent application Ser. No. 16/290,467, filed Mar. 1, 2019, which is a Continuation of prior U.S. patent application Ser. No. 15/942,370, filed Mar. 30, 2018, the contents of which are incorporated herein in their entireties.

### FIELD

The present disclosure relates to video gaming devices.

### BACKGROUND

Gaming systems accept wagers from players in exchange for opportunities to win awards or prizes. Current gaming systems combine various specialized computing technologies to provide systems adapted to gain the attention of players and to keep them engaged with the gaming systems. To retain players' interest, gaming systems that offer new and unconventional functionality are needed.

### SUMMARY

In various implementations, a gaming system and method are disclosed as having a plurality of different symbol sets where the different symbol sets are each associated with different hit (win) rate frequencies. By varying the symbols sets used for different plays of a game, the gaming system can alter how frequently a player wins a game. In some implementations, by using symbol sets with low hit rate frequencies for some plays of a game combined with symbol sets with high hit rate frequencies for other plays of the game, the gaming system can increase the chance that sequential plays of a game will result in winning outcomes. These increased chances of creating winning outcomes for sequential plays of a game creates clusters of winning “streaks”.

In one such implementation, the gaming system may include a plurality of symbol sets. Each symbol set may include a plurality of different symbols. Each symbol set may be associated with a different probability of achieving a predetermined outcome. The gaming system may select a first one of the plurality of symbol sets to use to generate symbols for a play of a game. Based on the outcome of the play of the game, the gaming system may select a different symbol set associated with a different probability of achieving the outcome. In some implementations, the selected new symbol set may have a higher probability of achieving the outcome than the previously used symbol set. The higher probability of achieving the outcome increases the chance that the subsequently played game(s) will also result in achieving the outcome for the player. The gaming system may select another symbol set when the gaming system generates a different outcome. The other symbol set may have a lower probability of achieving the outcome than the previously selected symbol set.

In various implementations, the symbol sets may include sets of reel strips. The gaming system may include a plurality of reel strip sets. Each reel strip set may include a plurality of reel strips, where each reel strip includes a plurality of symbols associated with a reel of the gaming system. Each reel strip set may have a different probability of achieving a first predetermined outcome. In one implementation, the first predetermined outcome is a winning outcome. If the gaming system generates the first predetermined outcome, the gaming system may select a different reel strip set having a different probability of achieving a first predetermined outcome. In some implementations, the selected new reel strip set may be associated with a higher probability of achieving the first predetermined outcome than the prior reel strip set. The higher probability of achieving the first predetermined outcome increases the chance that the subsequently played game(s) will also result in achieving the first predetermined outcome for the player. The gaming system may select another reel strip set upon the occurrence of a second predetermined outcome. In one implementation, the second predetermined outcome is a non-winning outcome. The other selected reel strip set may have a lower probability of achieving a first predetermined outcome than the immediately prior reel strip set. It should be appreciated that a winning outcome, in one implementation, may include outcomes resulting in any amount of award or value being returned to the player. In one implementation, a winning outcome may include outcomes resulting in a predetermined amount or greater of award or value being returned to the player. It should be appreciated that outcomes other than winning outcomes and non-winning outcomes are contemplated. In one implementation, a predetermined outcome may include a particular symbol or symbol combination being generated by the gaming system.

In one implementation, the gaming system and method having variable symbol sets for variable win frequency gaming includes a plurality of reel strip sets. The plurality of reel strip sets may include a first reel strip set and a second reel strip set. Each reel strip set may include a plurality of reel strips, where each reel strip includes a plurality of symbols associated with a reel of the gaming system. Each reel strip set may have a different hit rate frequency. In one implementation, the gaming system may have two reel strip sets. In other implementations, the gaming system may have three or more reel strip sets. Further, each reel strip set may have identical or nearly identical return to player (RTP) values. After a winning outcome on the gaming system is generated, the gaming system selects a different reel strip set from the plurality of reel strip sets. In some implementations, the selected new reel strip set may have a higher hit rate frequency than the prior reel strip set. The higher hit rate frequency reel strip set increases the chance that the subsequently played game(s) will also result in winning outcomes for the player. Upon the occurrence of a non-winning outcome, the gaming system may select a reel strip set having a hit rate frequency that is lower than the prior selected reel strip set. In this manner, the gaming system may select and utilize a different reel strip set from a plurality of reel strip sets to vary the player experience with the gaming system.

In one implementation, the gaming system may have a first plurality of reel strip sets and a second plurality of reel strip sets. The gaming system may randomly select a first reel strip set from a first plurality of reel strip sets for a play of a game if the outcome of the previous game did not generate a winning outcome. The gaming system may continue to randomly select a first reel strip set from a first plurality of reel strip sets for each game until a winning outcome is generated by the gaming system. For a subsequent game after a winning outcome is generated, the gaming system may select a second reel strip set from a second plurality of reel strip sets to apply to the reels of the gaming system. The second plurality of reel strip sets contain second reel strip sets that have a higher hit rate frequency than the first reel strip sets contained in the first plurality of reel strip sets. The gaming system may continue play utilizing a second reel strip set selected from the second plurality of reel strip sets until an occurrence of a non-winning outcome. Upon the occurrence of a non-winning outcome, the gaming system may return to randomly selecting a first reel strip set from a first plurality of reel strips sets. In this manner, when a winning outcome is generated, the gaming system increases the likelihood of obtaining a winning outcome in the subsequent game and thereby providing a greater likelihood of the player experiencing a winning streak.

Additional implementations of the aspects described herein allow the gaming system to create additional gaming system features and operations. In some implementations, the gaming system may continue utilizing a second reel strip set selected from the second plurality of reel strip sets for a determined number of plays of the game without regard to the occurrence of a non-winning outcome. In some implementations, the gaming system may continue play utilizing a second reel strip set selected from the second plurality of reel strip sets so that a winning outcome is produced within a determined number of plays of the game. In some implementations, the gaming system may associate multiplier values with reel strip sets so that award values associated with certain symbol combinations are multiplied based upon the multiplier value. In some implementations, the gaming system may include a signifier to alert the player that the gaming system has altered or changed gaming system features or operations.

### BRIEF DESCRIPTION OF THE DRAWINGS

FIG. 1 is a perspective view of an implementation of a stand-alone gaming device of a gaming system.

FIG. 2 is a functional block diagram of the gaming device technology components of a gaming system.

FIGS. 3A and 3B illustrate screen shots of one implementation of a gaming system having varying symbol sets for variable win frequency gaming.

FIG. 4 illustrates one implementation of a set of reel strips having a low hit rate frequency.

FIG. 5 illustrates one implementation of a set of reel strips having a high hit rate frequency.

FIGS. 6A and 6B illustrate one implementation of a method of operating the gaming system to provide variable symbol sets for variable win frequency gaming.

FIG. 7 is a graphical representation of a decision tree representation of one implementation of the gaming system and method using variable symbol sets for variable win frequency gaming.

FIGS. 8A, 8B, and 8C are graphical representations of one implementation of a timeline showing game outcomes over time on a gaming system utilizing variable symbol sets having different hit rate frequencies.

FIGS. 9A and 9B are state diagrams representations of implementations of the gaming system and method using variable symbol sets for variable win frequency gaming.

### DETAILED DESCRIPTION

Various implementations of a gaming system and method are disclosed as having variable reel strips, (e.g., varying symbol sets,) for providing variable win frequency. The gaming system includes a plurality of reel strips sets. A reel strip defines the symbols and the symbol distribution utilized in the play of a video reel wagering game. The symbol distribution may alternatively be viewed as weights or probabilities associated with each of the symbols of being generated in a play of a game on the gaming system. It should therefore be appreciated that the gaming system does not require physical reel strips. A reel strip set defines all reel strips necessary for an execution of a game. Each reel strip set may be characterized by a hit rate frequency value and a return to player (RTP) value. The reel strip sets may be grouped into a first reel strip set and a second reel strip set. In some implementations, the reel strip set may be grouped into a first plurality of reel strip sets and a second plurality of reel strip sets. The reel strip sets grouped in the first plurality of reel strip sets may have a lower hit rate frequency value relative to the reel strip sets grouped in the second plurality of reel strip sets. The reel strip sets grouped in the second plurality of reel strip sets may have a higher hit rate frequency value relative to the reel strip sets grouped in the first plurality of reel strip sets.

In an implementation of one method of operating the gaming system, the gaming system may receive a monetary value from a player via a value acceptor device. The gaming system may determine, via a processor of the gaming device, a credit balance based on the monetary value received. The gaming system may receive, via a player input device, a wager for a play of a game at the gaming device. The gaming system may use a processor of the gaming device to update a gaming credit balance in accordance with the amount of the wager. The gaming system may determine the outcome of the last game played on the gaming system. The gaming system may select a reel strip set from one of a plurality of reel strip sets based upon the outcome of the last game played on the gaming system. If the outcome of the last game played on the gaming system was a non-winning outcome, the gaming system may select a reel strip set from a first plurality of reel strip sets having a low hit rate frequency value. If the outcome of the last game played on the gaming system was a winning outcome, the gaming system may select a reel strip set from a second plurality of reel strip sets having a higher hit rate frequency value than the first plurality of reel strip sets. The gaming system may receive, via a player input device, a request to initiate a play of the game. The gaming system may use a random number generator to randomly generate a plurality of symbols from the reel strip for each game reel, based upon the reel strip set selected. The gaming system may display the randomly generated plurality of symbols in a visible symbol display area. The gaming system may then evaluate, by the processor of the gaming system, the displayed symbols for winning symbol combinations along wagered pay lines. The gaming system may update, by the processor of the gaming system, the gaming credit balance in accordance with any award amount based on the winning symbol combinations. The gaming system may dispense a value to the player via a value dispenser of the gaming system in accordance with the player gaming credit balance when receiving a signal to cash out or otherwise end the gaming session at the gaming system.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. In some implementations, a gaming system includes: a display device, an input device, a value acceptor, a value dispenser, a random number generator, a memory device, and a processor, where the memory device stores program instructions that, when executed by the processor, cause the processor to perform operational functions. For example, in some implementations, the gaming system may establish a credit balance based on a value received by the value acceptor. The gaming system may receive, in some implementations, via the input device, a wager for a play of a game using the credit balance. The gaming system may, in some implementations, determine an operating status of the gaming system. The gaming system may select symbols sets based upon the operating status. In some implementations, the gaming system may display, using the display device, a symbol display area including a plurality of randomly generated symbols from the selected symbol sets. The gaming system may evaluate the plurality of randomly generated symbols for predetermined symbol combinations, and the gaming system may determine one or more awards based upon the plurality of randomly generated symbols corresponding to the one or more predetermined symbol combinations. The gaming system may issue a monetary value from the value dispenser based on the one or more awards upon receipt of a cash out request. Implementations of these aspects include corresponding computer systems, apparatus, and computer programs recorded on one or more computer storage devices, each configured to perform the actions of the methods.

Further, some implementations may include one or more of the following features: The gaming system operating status may, in some implementations, cause the gaming system to operate with a high probability of generating a winning outcome. The gaming system operating status may further cause the processor to select symbol sets from a plurality of symbol sets having a high probability of generating a winning outcome where, in some implementations, selected symbol sets may have a probability of generating a winning outcome greater than 50 percent. The gaming system may continue selection of symbol sets based upon the operation status until a predetermined number of plays of the game have been executed. The gaming system, in some implementations, may have an operating status that may cause the gaming system to generate a winning outcome within a determined number of plays of the game. In some implementations, the gaming system may predetermine the determined number of plays of the game. In some implementations, the gaming system may randomly determine the determined number of plays of the game. In some implementations, the operating status may further cause the processor to select a symbol set from a plurality of symbol sets having a high probability of generating a winning outcome. In some implementations, when the generated outcome is not a winning outcome, the operating status may cause the processor to select a symbol set having a higher probability of generating a winning outcome than the previously selected symbol set. Implementations of the described techniques may include hardware, a method or process, or computer software on a computer-accessible medium.

### Gaming System Platform

The features and advantages of the gaming system and method described herein may be provided to a player via a gaming device platform that includes various structures and components for allowing player interaction with the gaming device. While only one gaming device platform will be described in detail herein, the features, objects, and advantages of the gaming system described herein may be implemented in one or more alternative gaming device platforms.

The features and advantages of the systems and methods described herein may be provided to a player via a gaming system that includes various structures and components for allowing player interaction with the gaming system. While some examples of gaming systems are described in detail herein, it is understood that the features, objects, and advantages of such gaming systems may be implemented in one or more alternative implementations consistent with the present disclosure.

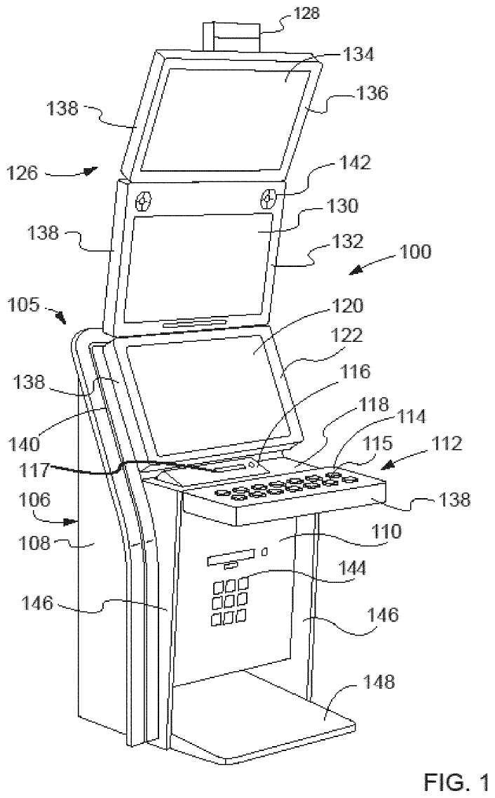

FIG. 1 shows a perspective view illustrating an example of gaming system 100 in accordance with aspects of the present disclosure. The gaming system 100 may be referred to as a slot machine and, as illustrated, includes a cabinet 105 (e.g., a housing) constructed so that a player can operate and play the gaming system 100 while standing or sitting. The cabinet 105 can include a lower cabinet body portion 106, which includes a pair of cabinet side panels 108 (one of which is visible in the perspective view of FIG. 1 and another that is partially visible in FIG. 1), a front panel 110, and a rear panel (not shown). Additionally, a base panel (not shown) and a top panel surface (not shown) may support a first game display device 120 and the player interaction area 112. The cabinet panels 105, 106, 108, 110 (as well as the base panel and the top panel surface) may be interconnected to form the cabinet 105, which encloses and houses components of the gaming system 100. The cabinet 105 may function to securely protect a local game controller and technology components, and to provide support for game display(s) and player input and output systems of the gaming system 100, such as described herein below.

While the example cabinet 105 is depicted as having a particular shape, structure, and organization, it should be appreciated that a wide variety of cabinet enclosure sizes, shapes, and designs are possible for the gaming system 100. For example, the cabinet panels 105, 106, 108, 110 (as well as the base panel and the top panel surface) may be combined into fewer elements or divided into additional elements. Additionally, the positions of the displays (e.g., first display device 120) and input and output devices can be rearranged with respect to one another. In some implementations, the gaming system 100 may include more or fewer components than described herein.

A player can interact with the gaming system 100 in various ways to direct wagering and game activities. The cabinet 105 may include player input systems and output systems generally designated as the player interaction area 112. In some implementations, the player interaction area 112 can be located on the front top side of cabinet 105 and, as shown, on a panel structure that extends outwardly from the gaming system 100 in a player's direction. The player interaction area 112 may contain player input and output systems, including a player control area 114 with one or more input devices 115, a player value acceptor and dispenser area 116, and player convenience input area 118. It should be appreciated that the player interaction area 112 can be placed in other suitable areas of the gaming system 100. In some implementations, the player input and output systems of player interaction area 112 can be positioned in areas apart from each other, such that the player input and output systems are not all contained in a player interaction area 112.

In some implementations, the player control area 114 may include the input devices 115, such as buttons and touch sensitive areas, through with which players may interact with the gaming system 100 to direct game activities. The cabinet 105 can provide an easily accessible location and support for player input and output interactions with the gaming system 100, including gaming control interactions and value wagering interactions. Although the gaming system 100 illustrated in FIG. 1 shows the input devices 115 of the player control area 114 as physical controls (e.g., buttons), it is understood that in some implementations, a player's gaming control inputs could be made using physical controls (e.g., hardware buttons, levers, etc.), “soft” controls (e.g., software driven buttons) located on a gaming display and activated by player touch (e.g., touch screen interfaces), motion detection interfaces, etc. It should be appreciated that a player's gaming control inputs can be made using a suitable combination of input devices.

In some implementations, when a player depresses or selects one of the input devices 115, that input device 115 may cause requests, messages, and/or signals to be sent to one or more processors of the gaming system 100. The input devices 115 may be associated with, but are not limited to the following game controls: game selection button(s) (e.g., where more than one game is provided in a single gaming system 100); gaming denomination value selection button(s); wager selection button(s) for the player to indicate or select the desired wager value for a game; pay line selection button(s) for selecting the number of active pay lines in game implementations that provide multiple pay line wagering; reel spin button(s) for players to initiate one or more reels to spin in a game; a repeat last bet button for players to conveniently repeat the last game's preference and wager selections in a new game; a cash-out button for player extraction of available player credits; an attendant call button; and gaming information buttons such as show pay tables, show game rules, or show other game-related information. It should be appreciated that input devices 115 may include other suitable game control inputs.

The player value acceptor and dispenser area 116 may include one or more value acceptance and value distribution devices 117 that allow the player to interact with the gaming system 100 and input value (e.g., money, currency, etc.) to risk or otherwise place a wager (e.g., a monetary value) on one or more outcomes of a game. The value acceptance and value distribution devices 117 may return winnings to the player via some form of value distribution (e.g., currency, paper ticket vouchers, credit on a player tracking card, credit stored in a central database, etc.). In some implementations, in the player value acceptor and dispenser area 116, a player can supply monetary value to the gaming system 100 via the value acceptance and value distribution devices 117. In some implementations, the value acceptance and value distribution devices 117 may accept any one or more of the following from a player to establish a gaming credit balance: coins, bills, tokens, tickets/vouchers, player ID cards, credit cards, or other suitable forms of value. Thus, if the gaming system 100 accepts coins and bill, the value acceptance and value distribution devices 117 may comprise a currency bill validator and a coin validator. Likewise, if the gaming system 100 accepts tickets, the value acceptance and value distribution devices 117 may comprise a ticket acceptor that receives tickets or vouchers representing some monetary value. The ticket acceptor may include a bar code reader, or other appropriate code reader, for reading the encoded value contained by the player's ticket or voucher. In some implementations, value acceptance and value distribution devices 117 can accept more than one type of value. In some implementations, the player value acceptor and dispenser area 116 may include multiple different value acceptance and value distribution devices 117 that accept different types of value from players.

In some implementations, upon receipt of some suitable type of value from the player, the value acceptance and value distribution devices 117 of the player value acceptor and dispenser area 116 can perform validation on the player supplied value using appropriate hardware readers (e.g., determining that the currency bills/coins/tokens/ticket/voucher/card are genuine). If the validation result is positive on player supplied value, the value acceptance and value distribution devices 117 can generate a message/signal to a processor of the gaming system 100 that establishes a gaming credit balance for playing one or more games on gaming system 100.

In some implementations, the value acceptance and value distribution devices 117 dispenses a monetary value, or a representation thereof, from the gaming system 100 when a player chooses to “cash out” the gaming credit balance (e.g., remove value from the gaming system 100). The player may select an input device 115 associated with a cash out function. The input device 115 may cause a request/message/signal to be sent to a processor of the gaming system 100 to perform a cash out process. The player can cash out at any suitable time. When a player cashes out the value contained on a credit meter (not shown) of gaming system 100, a processor of gaming system 100 may cause a printer included in the value acceptance and value distribution devices 117 to print and dispense a coded ticket or voucher through a dispensing slot to the player. The coded ticket or voucher may be a bar-coded ticket or any other suitable code (PDF517 coding or quick response (QR) coding). This ticket can then be used as value input at another gaming system, or converted to currency at a conveniently located kiosk or cashier counter located near the gaming system. Alternatively, the processor of gaming system 100 may cause a currency bill dispenser or a coin dispenser included in the value acceptance and value distribution devices 117 to dispense the value contained on the credit meter of gaming system 100.

Various combinations of the above value acceptance and value distribution arrangements are possible. The gaming system 100 may include other value acceptance and value distribution mechanisms in the player value acceptor and dispenser area 116. For example, the value acceptance and value distribution devices 117 may include a magnetic strip or chip card reader/writer in order to accept value from and transfer value to a magnetic strip or an embedded chip card. In other implementations, the value acceptance and value distribution devices 117 may include hardware for transferring (and receiving) non-traditional currencies to players such as digital currencies (e.g., bitcoin). In some implementations, the gaming system 100 may update a record of the player's credit meter balance to a remote database.

In some implementations, the value acceptance and value distribution devices 117 may include a card reader that accepts and reads any of a variety of magnetic strip or imbedded chip smart cards that convey machine readable information. The card reader reads inserted cards, in the case of wagering, for the credit information of the player for cashless gaming. The card reader may, for player loyalty programs, utilize the information on the card to identify the player account associated with the card so the gaming activity on the gaming system 100 may be associated with the player account. Additionally, gaming system 100 may include a numeric or alphanumeric keypad (not shown) that enables player entry of a personal identification number or the like for secure access to card information.

In some implementations, a player convenience input area 118 may be included in the gaming system 100, as is shown in FIG. 1. In various implementations, player convenience input area 118 may have a variety of features and functions depending on the jurisdictional deployment of the gaming system 100. In some implementations, the player convenience input area 118 may house a magnetic strip card reader (not illustrated), integrated circuit chip card reader (not illustrated), or both, for reading cards associated with a player loyalty program. Player loyalty programs, also referred to as player tracking systems, provide magnetic strip or chip cards to players for insertion into the gaming system 100 during play. These player loyalty/players tracking cards may be associated with a player account and are utilized by the card-issuing entity to monitor, or track a player's gaming activity and build loyalty through player rewards of a variety of types. The player convenience input area 118 may include an input mechanism such as input buttons so that a player may input a personal identification number or other require player information associated with the player tracking card. Further, the input mechanism may also include a small display utilized to communicate player information to the player such as the player's current loyalty rewards.

In certain implementations, the player convenience input area 118 may include player convenience features such as a pocket for storage that allows players to store their personal items such as a mobile phone. The gaming system 100 may include one or more power charging ports (e.g., universal serial bus (USB) ports, etc.) that enables a player to charge their electronics or connect to services such as the Internet or food service. Further, player convenience input area 118 of the gaming system 100 may include buttons to request food or drink service if the gaming system is located in an establishment that has food and drink service. The gaming system 100 may be connected to a local or wide area network such that selection of the requested food or drink service may alert the establishment's hospitality staff to deliver the requested service directly to the gaming system 100.

The layout of the player control area 114, player value acceptor and dispenser area 116, and the player convenience input area 118 in gaming system 100 may be arranged differently than those disclosed and illustrated herein. The selections and arrangement of player device input locations and player device output locations on the cabinet 105 may be dependent upon the game buttons, the type of value wagered, and the player conveniences utilized in the deployment configuration of gaming system 100.

In some implementations, the lower cabinet body portion 106 includes the first game display device 120, which can be mounted atop or flush with a top panel surface of the lower cabinet body portion 106. The first game display device 120 can be, for example, a 27-inch liquid crystal display (LCD) display mounted in a widescreen orientation. However, any suitable display may be connected to gaming system 100 and placed in any suitable orientation. In the illustrated implementation, the first game display device 120 can be mounted within and framed by first display frame 122 which is, in turn, mounted upon lower cabinet body portion's top panel surface. In this manner, the first game display device 120 is both surrounded and secured within the first display frame 122 and raised above the cabinet's top panel surface. Additional features of the first display frame 122 are described below. Although not illustrated, it is understood that some implementations of the gaming system 100 may use a single first game display device 120 and not include additional game displays. For example, a single first game display device 120 may span the one or more portions of the cabinet 105 (e.g., lower body cabinet portion 106 and upper cabinet portion 126, described below) in place of other display devices (e.g., display devices 130 and 134, described below).

The lower cabinet body portion 106 can also support an upper cabinet portion 126. In some implementations, the upper cabinet portion 126 may be comprised of an upwardly extending support structure (not illustrated) that extends upwardly from the rear side of lower cabinet body portion 106 and configured to mechanically support one or more additional game display devices.

Gaming system 100 may include a cabinet top light 128. In some implementations, the cabinet top light 128 is capable of illumination in a variety of colors and can be utilized to indicate and communicate conditions of the gaming system 100 to gaming players and service personnel.

The upper cabinet portion support structure of gaming system 100 may conceal power and communication lines between (1) the control systems and components located within the lower cabinet body portion 106 and (2) the displays mounted on the upper cabinet portion 126 support structure.

In some implementations, as illustrated in FIG. 1, gaming system 100 may include one or more additional display devices, such as a second game display device 130 and/or a third game display device 134. The second game display device 130 and the third game display device 134 can be disposed generally in a vertical relationship and generally in alignment with the first game display device 120. Like the first game display device 120, the second game display device 130 and the third game display device 134 can be LCD display device or other suitable display devices and can be mounted in any suitable orientation in some implementations. Further, like the first game display device 120, the second game display device 130 and/or the third game display device 134 can be mounted within and framed by second display frame 132 and third display frame 136, respectively. The second display frame 132 and the third display frame 136 can be attached to the upper cabinet support structure and can protect the second game display device 130 and the third game display device 134. In some implementations, one or more of the game display devices 120, 130, and 134 may not include a display frame. In some implementations, one or more of the game display devices 120, 130, and 134 can be housed within a same display frame.

In some implementations, the first game display device 120, the second game display device 130, and the third game display device 134 can be disposed at an angle from each other to form a player-facing concave arc. However, in some implementations, the angles between the game display devices 120, 130, and 134 may be adjustable and may be smaller or greater than the angles illustrated in FIG. 1. Further, it is understood that in some implementations the displays may be disposed in a common plane relative to each other.

It also should be appreciated that in various implementations a variety of display technologies may be utilized equivalently and interchangeably with a variety of implementations of the gaming system. Equivalent display devices include all variations of liquid crystal displays, light emitting diode displays, and plasma displays.

In some implementations, different sized display devices may be combined to display gaming data on gaming system 100. As a non-limiting example, a 27-inch widescreen LCD display may be combined with a 20-inch portrait-oriented LCD or a light emitting diode (LED) display. The display devices could include organic light emitting diode displays (OLED) or other suitable display devices. This combination may be used, for example, with a third scrolling banner LED display. In alternative implementations, one, two, three, or more displays could be used in a variety of positions and orientations. Any suitable combination may be used. It should also be appreciated that a processor of gaming system 100 may communicate with the disclosed first game display device 120, second game display device 130, and third game display device 134 through a video card of gaming system 100 to produce the visible aspects of a game.

In some implementations, one or more of the first game display device 120, the second game display device 130, and the third game display device 134 may be fitted with a transparent touch sensitive overlay for sensing player touch inputs into the gaming system 100. The touch sensitive overlays can communicate with a processor of gaming system 100 to enable the player to interact with a game available on gaming system 100.

In some implementations, curved displays may be used for one or more of the display devices on gaming system 100. Similarly, any of the displays used for gaming system 100 can be based on flexible display technologies. For example, it is possible to utilize flexible display technologies to create uniquely shaped curving, wavy, or tubular display structures to provide one or more of the display devices of gaming system 100. Additionally, in some implementations flexible display technologies can be used in combination with fixed flat screen technologies.

While the gaming system 100 has been described as implemented with video technologies, in some implementations, mechanical game reels with reel strips containing game indicia and step motor controllers may be employed to provide game information to a player. In some implementations, the reel strips may include printed symbols. In another implementation, the mechanical game reels may include flexible video display technology as the reel strips on mechanical game reels. Thus, games implemented in video form can readily be implemented with mechanical game reels utilizing such display technology. Alternatively, in other implementations mechanical game reels with reels strips having fixed symbols displayed along the reel strip could be used to implement the game.

Dependent upon a housing style used in some implementations of the gaming system 100, a variety of other display technologies may be utilized in combination with the gaming system disclosed herein. For example, the gaming system 100 may have one or more display devices in addition to the main game display devices(s) in some implementations. For example, the gaming system 100 may include a player tracking device having a player tracking display which displays various information to the player regarding the player's status. The gaming system 100 may also include other game-related displays such as the wager display and the gaming credit balance meter display. These additional game-related displays may be separate display devices or may be displayed on any one or more of the first game display device 120, the second game display device 130, or the third game display device 134.

The gaming system 100 may also include cabinet lighting that can be used to, among other functions, attract players. In the example gaming system 100 illustrated in FIG. 1, attractive cabinet lighting is provided by frame accent lighting 138. The frame accent lighting 138 can be placed around any number of structures of gaming system 100. For example, the frame accent lighting 138 can be placed around the first display frame 122, the second display frame 132, the third display frame 136, and/or player interaction area 112.

The frame accent lighting 138 may include multiple components. In some implementations, the side edge pieces of the first display frame 122, the second display frame 132, the third display frame 136, and the edge structure of player interaction area 112 can be made of a translucent or transparent plastic or other suitable materials. Linear arrays, or strips, of light emitting diodes (LEDs) (not shown) on circuit boards may be mounted below or on the surface of the side edge pieces. In some implementations, the circuit boards are flexible circuit boards. These LED strips and transparent or translucent coverings may surround one or more gaming system displays frames, as well as the player interaction area, to highlight these areas.

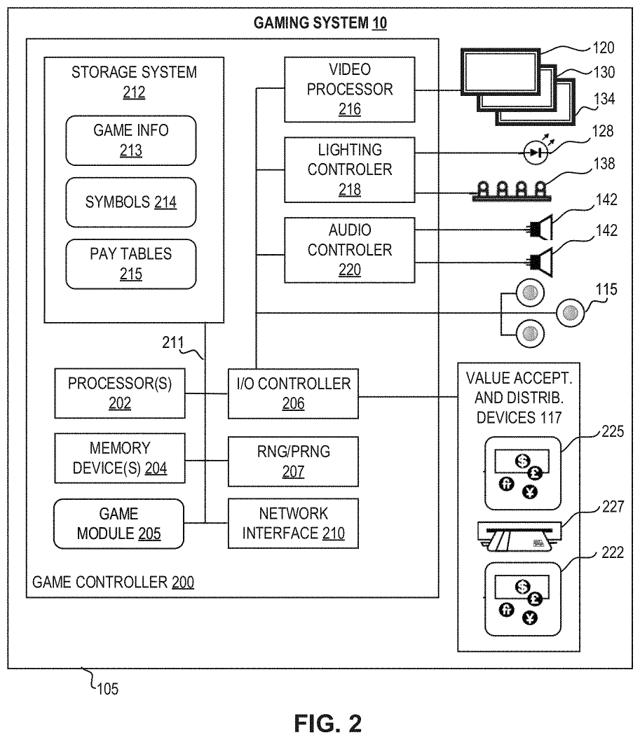

In some implementations, the individual LEDs mounted on the LED strips are of a type that can emit red, green, and blue light. In an alternative implementation, separate LEDs are used for the light colors. In some implementations, the LEDs or LED strips can be electrically connected and can be controlled by a cabinet lighting controller (e.g., cabinet lighting controller 218 in FIG. 2) in conjunction with a processor of the gaming system 100 to selectively mix the emitted light colors in a manner to create any color. The cabinet lighting controller can flash and vary lighting as desired. For example, cabinet edge lighting can change and flash in combination with music rhythms or in combination with game events. Other suitable variations are possible.

In some implementations, the cabinet 105 may include LED strip lighting or LED rope lighting to accentuate the cabinet and enhance the attractiveness of the gaming system 100 to players. LED rope lighting is a number of small light-emitting diode bulbs linked together and encased in a plastic, polyvinylchloride, or other suitable material to create a string of lights. For example, in one implementation illustrated in FIG. 1, the cabinet 105 includes cabinet accent lighting 140. In some implementations, the cabinet accent lighting 140 is LED rope lighting mounted flush with the front side edge of the cabinet side panels 108. The LED rope lighting can generate any of suitable colors, and are controlled by cabinet lighting controller and a processor of the gaming system 100 to selectively mix the emitted light colors in a manner to create any color in the same manner as the frame edge lighting.

In various implementations, the gaming system 100 includes one or more audio speakers 142 and appropriate driving electronics and sound cards so that game players may experience pleasing audio aspects of the gaming system 100. Audio is desirable to attract and maintain player interest in the gaming system 100. The gaming system 100 may also emit attraction sounds during any idle period of the gaming system 100. Game audio may add to the player's enjoyment of the gaming system 100 by providing music and sound effects designed to enhance and compliment the gaming experience. In FIG. 1, the audio speakers 142 are shown mounted on the upper corners of the second display frame 132. Any suitable number of additional audio speakers 142 may be provided on additional display frames or on the lower cabinet body portion 106 as desired.

The audio speakers 142 designed for emitting bass vibrations may be included in some implementations. Placement of the audio speakers 142 may be selected to enhance the sound emitting characteristics of the gaming system 100. For example, bass speakers or additional speakers 144 may be mounted inside lower cabinet body portion 106. Further, it is envisioned that in some implementations sound processing such as multichannel processing and surround sound processing are included in gaming system 100. Audio jacks for attachment of player headphones may also be provided in some implementations of gaming system 100 for the player to further enhance the audio experience of the game and to block out noise from other gaming systems.

In some implementations, the front panel 110 of the lower cabinet body portion 106 includes a removable panel or door, which can be opened for access to internal control system and technology components that are housed within the lower cabinet body portion 106 (discussed hereinbelow with respect to FIG. 2). The removable panel or door can be locked in some implementations. The front panel 110 may be flanked on vertical sides by cabinet side panel extensions 146 which serve to define a space below the player interaction area 112 for players to place their feet and legs while they are playing the gaming system 100 in a seated position. A foot rest 148, which may be cushioned, can positioned below the player interaction area 112 to enhance a player's ergonomic comfort while playing the gaming system 100. In some implementations, the edges of the player interaction area 112 may be ergonomically cushioned as well.

The gaming system 100 may be constructed using other suitable alternative forms and styles of gaming system housings that are not shown. For example, the cabinet 105 may have fewer or greater number of display devices for displaying games and game-related information to the player. If multiple display devices are used, the display devices may be of similar size, shape, and orientation or the display devices may be divergent from each other in one or more of their respective characteristics. The one or more display devices can be supported by, mounted upon, or contained within the cabinet 105 which can comprise a variety of shapes, sizes, and forms. The cabinet 105 can: protect and house the operational electronics; adequately support the display(s) in a position easily viewable for a seated or standing player, as necessary; and/or provide an easy location and support for all necessary player input/output systems, including gaming control interactions and wagering interactions. For example, in some implementations the gaming system 100 may include a housing style referred to as a “slant top” gaming device that is designed to be operated with the player comfortably seated. In this arrangement, generally, the gaming display(s) and all player input and output controls are located on a low, wide, surface that extends forwardly from the player on a horizontal plane and then slopes upwardly and away from the player's seated location.

In some implementations, housing styles of the cabinet 105 of gaming system 100 may include bar top or table top housing arrangements. These housings are generally small enough to be placed on top of an existing bar or table while providing the requisite gaming system housing functions of protection of/access to gaming electronics, displays, and player input and output functions described above.

In some implementations, the cabinet 105 may be an embedded housing. Embedded housings are built into structures designed to otherwise function as bars or tables in a gaming environment. Displays may be integral with the bar top or table top surface or the entire unit may be contained below a transparent bar or table top surface while controls are disposed on the lower front or side of the bar or table.

FIG. 2 shows a functional block diagram illustrating an example of a game controller 200 of a gaming system 100 in accordance with aspects of the present disclosure. The gaming system 100 can include a cabinet 105, one or more player input devices 115, one or more value acceptance and distribution devices 117, one or more display devices 120, 130, and 134, a cabinet top light 128, accent lighting 138, and one or more audio speakers 142, which can be the same or similar to that previously described herein. Additionally, implementations of the game controller 200 may include one or more processors 202, one or more memory devices 204 (e.g., random access memory, read only memory, etc.), one or more game modules 205, one or more input/output (I/O) controllers 206, one or more random number generators 207, one or more network interfaces 210, one or more communication channels 211 (e.g., a data bus), one or more video processors 216, one or more lighting controllers 218, and one or more audio controllers 220. In accordance with aspects of the present disclosure, the game controller 200 is configured to perform specialized game functions and operations, consistent with the implementations described herein. The functional elements shown in FIG. 2 cooperate, on a broad and general level, to function as a gaming system providing the functionality and operations detailed below. Such functionality and operations can be embodied in hardware, software, or a combination thereof. It is understood that the below described hardware includes the structures described, as well as the functional or operational equivalents of such structures. Further, it is understood that the below-described functions and operations can be performed by hardware, digital circuitry, computer software, computer firmware, or functionally equivalent combinations thereof.

The processor 202 can be one or more general-purpose processors, special-purpose processors, or other programmable data processing apparatuses providing the functionality and operations detailed herein. In some implementations, the processor 202 is specially configured with arithmetic logic units and math co-processors, also known as floating point units, for executing one or more games consistent with the various implementations disclosed herein. In some implementations, the processor 202 includes registers for holding instructions or other data, and cache memory for storing data for faster operation thereupon.

A controller, in some implementations, is a device or a software program that manages or directs the flow of data between two entities. Often, controllers are special purpose circuitry or software that solve a technical communications problem between different technology systems. In some implementations, a controller functions as an interface between two systems while managing the communications between the systems. In another implementation, a controller functions as an interface between a processor and a peripheral device and functions to control the peripheral device.

The memory device 204 and storage system 212 can be operatively and/or communicatively connected to the processor 202. In some implementations, the memory device 204 and/or the storage system 212 includes one or more types of memory structures. For example, the memory structures can include random access memory (RAMs) units, read only memory (ROMs), flash memory (e.g., solid state drives (SSDs)), electrically erasable/programmable read only memory (EEPROMs), etc. It should be appreciated that in some implementations, communication between the memory device 204, the storage system 212, and the processor 202 or another controller, encompasses the processor or controller accessing the memory device 204 and/or the storage system 212, exchanging data with the memory device 204 and/or the storage system 212 (e.g., reading/writing data to the memory device 204), or storing data to the memory device 204 and/or the storage system 212.

The memory device 204 and/or the storage system 212 may store program code, game code (collectively the “code” or “program instructions,” such as game module 205), and operational data (e.g., game info 213, symbols 214, and pay tables 215, or other suitable data) used in the operations of the game controller 200 to provide a gaming system that executes the gaming functions described hereinbelow. In an alternative implementation, the code and the operational data for the operation of the game controller 200 may be stored in a distributed manner such that some code is stored in memory device 204 (or storage system 212) and other code is stored remotely from the game controller 200. In some implementations, the code and the operational data used the operation of the game controller 200 includes, for example, basic input and output function data, instruction fetching data, bus and network communication protocol data, and like data for an operational gaming system. In some implementations, the code (e.g., the game module 205) and the operational data (e.g., game info 213, symbols 214, and pay tables 215, or other suitable data) used for the execution of the gaming features includes, for example, game image data, game rule data, pay table data, game mode and timing data, gaming value and wager parameter data, and random or pseudo-random number generation data.

In addition to the memory device 204 described above, in some implementations, the code and operational data for the operation of the gaming system described above may be stored in the storage system 212. The storage system 212 can be removable game cartridges or flash drives, a compact disk ROM, a digital versatile disk (DVD) optical storage technology, or suitable other fixed, non-transitory computer-readable storage devices. In some implementations, part or all of the code and operational data for operation of the gaming system or for execution of the game features may be stored in a remote memory structure and be downloaded to the memory device 204 via a network connection.

In some implementations, the game controller 200 may utilize any combination of computer-readable memory devices, such as random-access memory devices (RAMs), unalterable memory devices (ROMs), and mass storage devices for securely storing and securely communicating the software components or code that facilitate game play and other functions of the game controller 200. The memory device 204 may store software components or code that include various game data and game related control and execution software. In some implementations, the software components stored in the memory device 204 may include gaming system initialization software, system basic input and output software, operating system software, value acceptor software, value dispenser software, display image generation software, game symbol set image generation software, game rule execution software, game data set(s), random number generation software, system driver software, system data bus management software, audio generation and speaker driver software, and video generation and display driver software, and any other suitable software routines for operation of the game controller 200.

In some implementations, the memory device 204 and the storage system 212, with the software components, code, operational data, and other information may be secured and authenticated by authentication software stored in an unalterable memory device within the housing of the game controller 200. The game controller 200 may also include application specific integrated circuits (ASICs) to perform the security and authentication functions. At various time or events, such as before each play of a game, at a predetermined interval, upon transfer of any game data or any software components from a mass storage to the memory device 204, or upon demand, the game controller 200 (using a processor such as a processor 202 or a separate ASIC) may execute an authentication routine and perform an authentication of any software component or other data of the game controller 200. In some implementations, the software components of the gaming system 100 and game controller 200 may be prepared for authentication via creation and storage of an encrypted signature unique to one or more of the software components.

In some implementations, an encrypted signature may be created by utilizing a hash function on a software component or code to form a message digest (e.g., a hash of the software component) followed by a key encryption of the message digest to form an encrypted signature unique to the software component. In some implementations, the key encryption may be public key encryption, private key encryption, or any suitable key encryption schema. The encrypted signature may be stored with the gaming system software component, for example, in a mass storage device or an unalterable memory. During a software component authentication, the gaming system 100 executes one or more authentication routines utilizing the same hash function to operate on the software component to compute, or re-create, a new message digest for the software component. The new or re-created message digest may then be compared with a previously created message digest obtained by decrypting the stored encrypted signature. Matching message digests between the new and previously created message digests indicate that the software component is authentic and the game controller 200 may allow game play to proceed. In some implementations, when the message digests do not match, the game controller 200 may determine that the software component under authentication may be corrupted or fraudulent and game play may be halted. It should be appreciated that the game controller 200 may perform other suitable security and authentication checks on the game data or software components. Such authentication and security devices and functions are unique to gaming and casino industry to minimize or prevent fraud in gaming devices and gaming systems.

For a player to interact with the gaming system 100, the game controller 200 receives and processes player inputs from, e.g., input devices 115, and the game controller 200 causes processed results to be output or communicated to the player. In some implementations, the player inputs are recognized and processed or directed for processing by input/output (I/O) controller 206. Further, the I/O controller 206 may process and direct player outputs for communication to the player. The I/O controller 206 can function as the intermediary between the processor 202 and one or more input devices to control information and data flow therebetween. The I/O controller 206 may also function as the intermediary between the processor 202 and one or more output devices to control information and data flow therebetween. The I/O controller 206 is configured to understand the communication and operational details (such as hardware addresses) for the attached input devices and output devices. In this manner, processor 202 can be freed from the operational details of the peripheral I/O devices in some implementations. For example, in some implementations where an input or output device is changed or upgraded, the I/O controller 206 can be changed or updated without changing other gaming system components.

In some implementations, a player deposits value into a gaming system by inserting some form of currency or value into a value acceptor 225 for game play. Alternatively, a player deposits value into a gaming system by inserting an encoded paper ticket into a value acceptor 225 for game play in some implementations. The value acceptor 225 can be combined with a currency reader and validator, and a code reader for reading value encoded on paper tickets. In some implementations, the gaming system 100 may include different hardware for the paper ticket reader from the currency reader and validator. The value acceptor 225 may read, validate and communicate the amount of the inserted value to the processor 202. The processor 202 can establish a gaming credit balance for the player based on the communication from the value acceptor 225. The processor 202 can also communicate the player's credit balance on a credit balance meter display of the gaming system 100. During game play, the processor 202 may process a player's wagers and determine an amount of credits to debit from the player's credit balance. When a winning outcome is obtained, the processor 202 is configured to determine an amount of credits to add to the player's credit balance. It should be appreciated that the gaming system 100 may use one or more different processors to perform such calculations.

As previously mentioned with respect to FIG. 1, gaming system may use one or more of a variety of value acceptance systems. In some implementations, the value acceptor 225 could include magnetic strip or chip card readers to accept and transfer value. The value acceptor 225 may also be configured to accept and transfer non-traditional currencies such as digital currencies. In these implementations, I/O controller 206, a processor 202, or both may be configured with appropriate control instructions to communicate with the value acceptor 225 and extract value from the inserted item containing value. In some implementations, use of a magnetic strip or embedded chip card, for example a bank card, for value insertion requires the processor 202 to communicate, via network interface 210, with devices external to a gaming system 100.

In some implementations, a card reader 227 may be included in gaming system 100 to accept player loyalty cards. For example, the card reader 227 can extract account identifying information from the card and utilizes this information to access the associated account information stored remotely via the network interface 210. In implementations where player loyalty/player tracking systems are used with the gaming system 100, a player's loyalty account and record of gaming activity can be stored in a networked storage location or database. In some implementations, the processor 202 is configured to record the player's gaming activity in the memory device 204 and/or the storage system 212 during the duration of loyalty card insertion. When the loyalty card is removed from the card reader 227, recorded gaming activity is uploaded, via the network interface 210, to the remote storage location associated with the player's account in some implementations. In this manner, the player's gaming activity can be further processed and analyzed, and the player can be awarded loyalty rewards based upon his activity data at the gaming system 100.

In various implementations, the input devices 115 receive a player's game inputs and communicates the player's game inputs to the processor 202. The player's game inputs may include, but are not limited to, wager amounts, pay line selections, game control signals, game selections, and cash-out requests/signals. In some implementations, the input device 115 may generate signals/requests based on button presses, touch screen activations, or voice control. In some implementations, the player-initiated signals can be communicated to the processor 202 by the I/O controller 206. Further, the player-initiated signals may direct and inform execution of the game instructions stored in the memory device 204 and configured to be executed by the processor 202 in some implementations.

In some implementations, the gaming system 100 may include mechanical game reels and other electro-mechanical components to provide game displays and game outcomes (not shown). For example, mechanical game reels (e.g., mechanical game reels rotatable about a common axis) may include indicia or symbols fixedly positioned around the periphery of the mechanical game reels. The indicia or symbols fixedly positioned around the periphery of a mechanical game reel may form a reel strip. The indicia or symbols fixedly positioned on reel strip may comprise a set of symbols for that reel strip or reel. The indicia or symbols on the mechanical game reels are generally associated with separate, detectable reel stop positions. In some implementations, the mechanical game reels can be set into a spinning/rotation motion by pulling a lever or pushing a button of the gaming system 100. In some implementations, the gaming system 100 can stop the game reels by allowing the mechanical game reels to stop naturally, or actuating a suitable mechanical or electro-mechanical reel brake on a random timing basis. When the mechanical game reels stop rotating, the gaming system 100 may, using suitable detection mechanisms, determine one or more displayed stop positions of the mechanical game reels. Since the displayed stop positions of the mechanical game reels can be associated with respective indicia or symbols, the gaming system 100 can determine what combination of indicia or symbols are displayed at the stop positions. The gaming system 100 can also determine whether the displayed indicia or symbols result in one or more winning symbols and/or winning symbol combinations for a game outcome.

In some implementations, the displayed stop positions (e.g., corresponding to displayed indicia) can be determined using random numbers associated with the displayed stop positions/indicia/symbols of the mechanical reels. In some implementations, the processor 202 is configured to execute stored program code and instructions which generate random numbers or pseudo-random numbers for determining the displayed stop positions of the mechanical reels. The gaming system 100 can use the randomly generated numbers to determine which stop positions of the reels should be displayed for a game outcome.

In some implementations, a random number generator (RNG) 207 is a software module configured to be executed by the processor 202 for the generation of a true random or pseudo-random number. The code for RNG 207 may be stored in the memory device 204 or the storage system 212. The RNG 207 generates random numbers for use by the gaming system 100 during game execution. In some implementations, the gaming system 100 can utilize the random numbers for the random selection of one or more symbols (e.g., stop positions) along mechanical game reels.

In some implementations, the gaming system 100 uses video-based reels as simulations of the mechanical reels to provide game displays of game outcomes. In some implementations, the video-based reels are used in place of mechanical reels. In some implementations, the video-based reels are used in conjunction with mechanical reels or other mechanical components. Like a mechanical game reel, a video-based reel can be associated with a reel strip, where the reel strip includes a set of symbols or indicia. The set of symbols or indicia for a reel strip may be fixed or dynamic in various implementations. In some implementations, indicia or symbols can include, but are not limited to, numbers, letters, geometric figures, symbols, images, character, animations, blank symbols (e.g., the absence of symbols), or any other suitable graphical depiction. The gaming system 100 may include one or more video-based reels for a game. The gaming system 100 may include a particular reel strip associated with a particular video-based reel. In some implementations, each video-based reel can be associated with a separate reel strip (e.g., a separate set of symbols). The reel strips can be the same or different for different video-based reels. It should be appreciated that the language “reel strip(s)” is used merely for illustration purposes throughout this disclosure. In some implementations, predetermined reels strips may be used. In other implementations, a reel strip is a representation of a set of symbols, where symbols in the set of symbols are associated with a probability of being determined or generated for display in the visible symbol display areas of a video-based reel. Different reel strips (e.g., different sets of symbols) may include the same symbols associated with the same or different probabilities of being determined or generated. In some implementations, different reel strips may include different symbols. It should be appreciated that in some implementations, indicia or symbols can be used independently of a video-based reel. That is, some games on gaming system 100 may not use video-based reels or reel strips, but use random number determinations for game outcomes.

Returning to random number generation, symbols in the reel strips or sets of symbols can be associated with numbers for video-based reels similar to mechanical game reels. In some implementations, when the RNG 207 selects a number, a processor in conjunction with the memory devices 204 of the gaming system 100 can correlate the selected number to an associated symbol to determine what symbol has been randomly selected. In various implementations, once symbols are randomly selected based upon the random numbers generated by the RNG 207, the processor 202 can evaluate the displayed patterns of symbols or randomly determined numbers to determine one or more game outcomes. It should be appreciated that in some implementations, gaming system 100 may include a hardware based random number generator that is in communication with processor 202 to supply random numbers for random game symbol determination purposes. The hardware based random number generator may be incorporated into the processor 202 or can be separate from the processor 202.

Returning to FIG. 2, the game controller 200 controls the function and output of output devices utilized by a gaming system. In various implementations, the I/O controller 206 serves as an interface unit between the processor 202 and output devices, such as video processor 216, cabinet lighting controller 218, audio controller 220, and value dispenser 222.

In some implementations, the video processor 216 communicates with the processor 202 to render at least some of the game graphics, video displays, and information on one or more video display devices (e.g., game display devices 120, 130, and 134). In some implementations, the video processor 216 includes one or more processors, controllers, and/or graphics cards for processing the game images, outcomes, and animated displays and coordinating the processed data to be display between, among, or across any or all display devices. In various implementations, this may include being configured to simulate objects and the movement of objects which represent video game reels containing symbol sets.

It should be appreciated that in certain other implementations where gaming system 100 includes physical mechanical game reels to display game symbols or other game features, reel controllers and stepper motors can be provided in lieu of or in addition to video processor 216.

In implementations which utilize cabinet lighting as described with respect to FIG. 1, a cabinet lighting controller 218 may be utilized to coordinate and control the color and timing of cabinet lighting displays with processor 202. In certain implementations which utilize sound design, processor 202 may utilize audio controller 220 to coordinate and control the sound emissions. In some implementations, audio controller 220 may include one or more audio processing cards for generating sound and for driving the one, two or more speakers 142 that may be included with the gaming system 100.

In various implementations, players may request their remaining credit value by selecting one of the input devices 115, which in turn makes a request or initiates a signal that is communicated to the processor 202, such as via the I/O controller 206. In some implementations, the signal triggers a readout of the player's credit balance from a credit balance meter and the processor 202 initiates a value dispensing signal which, in turn, can be communicated to the value dispenser 222. In some implementations, the value dispenser 222 can be controlled to issue the player's credit value using any of the types of value discussed herein. In some implementations, the player's credit value may be issued to the player via a printed and dispensed encoded paper ticket or token which the player can then exchange at a special purpose kiosk or cashier location for the monetary value encoded into the ticket or token. In some implementations, the processor 202 can direct the value dispenser 222 to issue to the player an appropriate amount of coin or bills directly to the player. Additionally, or alternatively, in some implementations, the player may have the option to electronically direct the credit value to an account associated with the player. It should be appreciated that any suitable combination of forgoing may be available at gaming system 100.

In some implementations, the game controller 200 may communicate with one or more devices outside the gaming system 100. For example, gaming system 100 may be connected to a larger network via a local area network (LAN) or a wide area network (WAN). The game controller 200 may communicate with one or more central servers, controllers, or remote devices to execute games, establish credit balances, participate in progressive jackpots, etc. In some implementations, network communications and connections can be accomplished via a network interface 210. Network interface 210 can be a digital circuit board or card installed in game controller 200 to provide network communications with external devices. Network interface 210 may include wired and/or wireless communication hardware.

In some implementations, various additional features and functions are performed by the game controller 200. For example, the game controller 200 may be specially configured with software to track game play events that occur on the gaming system 100. In some implementations, the game controller 200 may audit recorded monetary transactions, including wager amounts, game outcomes, game winnings, and game payouts that occur through the value dispenser 222. Further, some implementations of gaming system may include security software to assist in protecting the gaming system 100 from tampering or alteration attempts.

### Gaming System Operation

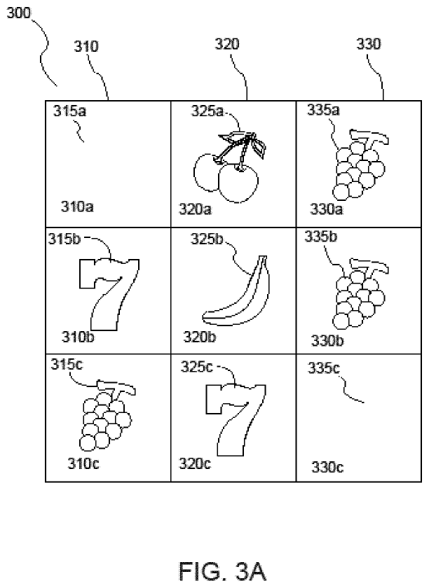

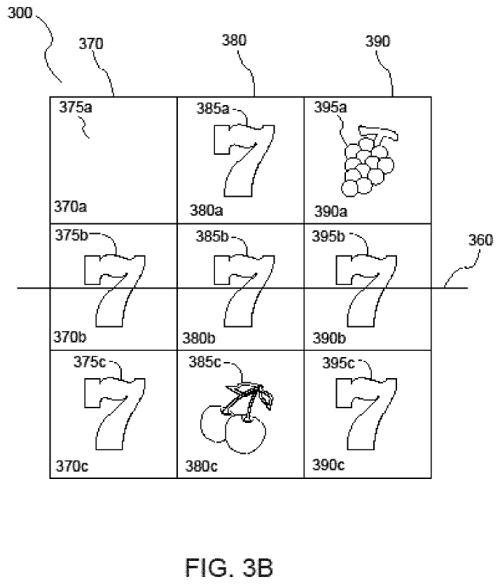

In FIGS. 3A, 3B, 4-7, 8A-8C, and 9A-9B, a gaming system and method are disclosed as having variable symbol sets for variable win frequency gaming. The gaming system includes a plurality of symbol sets. In some implementations, the plurality of symbol sets may be represented as a plurality of reel strip sets. For ease of visualizing the plurality of symbol sets, the figures will be described in the context of the plurality of reel strip sets. Each reel strip set may include a plurality of reel strips, where each reel strip includes a plurality of symbols associated with a reel of the gaming system. Each reel strip set may have a different hit rate frequency. Further, each reel strip set may have identical or nearly identical return to player (RTP) values.

In one implementation, the gaming system may randomly select a first reel strip set for generating game outcomes. After the gaming system generates a winning outcome, the gaming system may select a second reel strip set from the plurality of reel strip sets. In some implementations, the second reel strip set may have a higher hit rate frequency than the first reel strip set. The second reel strip set increases the chance that the subsequently played game(s) will also result in winning outcomes for the player. Play may continue until a non-winning outcome is generated. The gaming system may select the first reel strip set upon the occurrence of a non-winning outcome. In some implementations, the first reel strip set may have a lower hit rate frequency than the second reel strip. In this manner, the gaming system may select and utilize a different reel strip set from a plurality of reel strip sets to vary the player experience with the gaming system. It should be appreciated that the use of the relative terms “higher” and “lower” with “hit rate frequency” value throughout this disclosure means “greater than” and “less than,” when compared relative to each other. It should be appreciated that a winning outcome, in one implementation, may include outcomes resulting in any amount of award or value being returned to the player. In one implementation, a winning outcome may include outcomes resulting in a predetermined amount or greater of award or value being returned to the player.

FIGS. 3A and 3B illustrate screen shots of one implementation of a video display of a gaming system and method having variable symbol sets for variable win frequency gaming.

FIG. 3A illustrates one implementation of a game screen 300 that the gaming device 100 may display on a display device. In one implementation, game screen 300 may be displayed on first display 120of gaming device 100 illustrated in FIG. 1. However, any other suitable display may be used. The game screen 300 displays a set of a plurality of reels 310, 320, and 330 as illustrated in FIG. 3A. It should be appreciated that “reel” as used herein may, in some implementations, refer to a video display area (e.g., a virtual reel) for displaying one or more symbols randomly generated from a reel strip set. As also illustrated in FIG. 3A, the reels 310, 320, and 330 are displayed substantially side by side. It should be appreciated that reels 310, 320, and 330 can be displayed with any suitable amount of separation or no separation. It should be appreciated that the game shown in game screen 300 is merely representative and may have more or fewer game elements shown in the game screen 300. For example, in some implementations, game screen 300 may have additional or fewer game reel display areas.

Each of reels 310, 320, and 330 are associated with one of a plurality of sets of symbols, where each of the plurality of sets of symbols includes a plurality of symbols. Each set of symbols of the plurality of sets of symbols associated with each reel is referred to herein as a “reel strip.” It should be appreciated that the language “reel strip(s)” is used merely for illustration purposes throughout this disclosure. In some implementations, predetermined reels strips may be used. In other implementations, a reel strip is a representation of a set of symbols, where each of the symbols in the set of symbols is associated with a probability of being generated for display in the visible symbol display areas of the virtual reel. In some such implementations, an actual or physical reel strip is not used in the game. Each of these different sets of symbols associated with a reel, (e.g., each reel strip) may include the same symbols associated with the same or different probabilities of being generated. In other implementations, these different reel strips may include different symbols.

Each reel 310, 320, and 330 may be associated with the same or a different reel strip (e.g., the same plurality of symbols from the first set of symbols, or a different plurality of symbols from the first set of symbols). The set of symbols may be predefined and may include numbers, letters, geometric figures, symbols, images, character, blank symbols (e.g., the absence of symbols), animations, or any other suitable graphical depiction. The symbols in the set of symbols may have game functions associated therewith. The associated game functions may include pay symbols and special or designated symbols. In one implementation, the special or designated symbols may include scatter symbols or wild symbols.

In one implementation, a set of reel strips containing the reel strip for each reel of a gaming system is predefined. For example, in a three reel game, a reel strip set may contain at least three reel strips which may be associated with the reels and utilized in the play of a game. In a like manner, in an implementation of a five reel game, a reel strip set may contain at least five reel strips which may be associated with the reels and utilized in a play of a game. It should be appreciated that any number of reel strips may be associated as a reel strip set in some implementations,

The probability of any combination of symbols being randomly generated and displayed on a gaming display is a mathematical function of the number of symbols contained on a reel strip, and the number of reels in a game. For example, consider a three reel gaming system having 20 symbols associated with each reel strip of the reel strip set for the three reels of the gaming system. The probability that any one particular combination of symbols will be randomly generated across the three reels is 1/(20×20×20) or a 1 in 8,000 chance. Stated differently, if a three reel gaming system utilizes three 20 symbol reel strips in a reel strip set, there are 8,000 equally possible outcomes for each play of a game. In contrast, consider a five reel gaming system having 20 symbols associated with each reel strip of the five reels of the gaming system. The probability that any one particular combination of symbols will be randomly generated across the five reels is 1/(20×20×20×20×20) or a 1 in 3,200,000 chance. Thus, if a five reel gaming system utilizes five 20 symbol reel strips in a reel strip set, there are 3,200,000 equally possible outcomes for each play of a game. As can be appreciated, in some implementations more or less than twenty symbols may be associated with a reel strip, and the number of symbols associated with a reel strip may be different from the number of symbols associated with another reel strip contained in a reel strip set.

In one implementation, because a reel strip set may be predefined, a reel strip set may have a known hit rate frequency value and a known return to player or RTP value. The hit rate frequency value and the RTP value are statistical characteristics of the reel strip set and the defined pay table of a game, where the pay table of the game associates an award value with certain game symbol combination outcomes. The hit rate frequency and the RTP values may be calculated and may be utilized to describe or characterize a game.

The percentage “hit rate” or the “hit rate frequency,” as utilized herein, refers generally to the theoretical percentage of expected winning games over a long period of time on a gaming system played with a particular reel strip set. The hit rate frequency may be calculated as the total number of possible winning outcomes divided by the total number of possible symbol combinations. Returning to the example three reel gaming system having 20 symbols associated with each reel strip of the reel strip set for the three reels of the game, there are 8000 possible outcomes for each play of this gaming system. In one implementation, if 800 of these outcomes are set (e.g. by the pay table of the game) to produce a winning outcome to a player, a player will likely generate a winning outcome on 10% of the plays. The reel strip set, in this implementation, has a hit rate frequency of 10%. In another implementation of the same gaming system, if 4000 of the possible 8000 outcomes are set to produce a winning outcome to a player, a player will likely generate a winning outcome on 50% of the plays. The reel strip set in this implementation has a hit rate frequency of 50%. As can be appreciated from this example, the hit rate frequency of a reel strip set is dependent upon the distribution of symbols on the reel strip and the defined winning outcomes (e.g., the pay table) of the game. The rate at which a player achieves winning outcomes on a gaming system may enhance the player's satisfaction with the game.

The percentage “return to player,” or RTP (followed by a numeric percentage, e.g. RTP 92.8%), as utilized herein, refers generally to the theoretical payout percentage, or the return (of value) to player, of a gaming system over a long period of time. The RTP percentage describes the expected ratio of money paid out to money wagered of a gaming system. The RTP percentage can also be viewed as defining the hold of the gaming system, e.g. the amount of money retained by the gaming system (e.g., the casino or “house”). For example, an RTP value of 92.8% means that over many plays of a gaming system utilizing a particular reel strip set, an average of $92.80 will be paid out for every $100 wagered on the gaming system. The remaining $7.20 wagered on the gaming system will be retained by the house. In a like manner, a RTP value of 86% means that over many plays of a gaming system utilizing a particular reel strip set, an average of $86 will be paid out for every $100 wager on the gaming system. The remaining $14 wagered on the gaming system will be retained by the house.

Generally, the RTP for a three reel gaming system using a 20 symbol reel strip set may be calculated by identifying the defined winning outcome combinations for the gaming system and calculating a probability of the occurrence of each one of the defined winning combinations. The probabilities of occurrence of each one of the defined winning outcome combinations are then summed to obtain the theoretical RTP of the reel strip set.

Returning to the example used above, in a three reel gaming system having 20 symbols associated with each reel strip of the reel strip set, there are 8000 possible outcomes for each play of this game. In one implementation, suppose there is only one defined symbol combination that produces a winning outcome, and the winning outcome combination pays out 7500 multiplied by (“7,500×”) the unit wagered, the theoretical RTP for this gaming system is 7500/(20×20×20) or 7500/8000 which equals 0.9375 or 93.75%. In this same example of a three reel gaming system having 20 symbols associated with each reel strip of the reel strip set, if there are 800 symbol combinations that produces a winning outcome, and each winning outcome combination pays out 8× the unit wagered, the theoretical RTP may be calculated as 800×(8/(20×20×20) or 800×(8/8000) which equal 0.8 or 80%. In yet another example using this same three reel gaming system having eight winning outcomes distributed as one winning outcome paying 5000×the unit wagered, two winning outcomes paying 500× the unit wagered and five winning outcomes paying 250× the unit wagered, the theoretical RTP calculation would be: 5000/(20×20×20)+2×(500/(20×20×20))+5×(250/(20×20×20)) which equals 0.625+(3×0.0625)+(5×0.03125). In this case, the theoretical RTP for this gaming system is 0.90625, or 90.625%.

A player of each of the above mentioned example games will have a different gaming experience. Thus, a gaming system having the same three reels and the same reel strip set may produce different gaming experiences based upon the definition of winning outcome symbol combinations and their respective associated pay out award values. It should be appreciated that although in the example implementations the payout award is described as an integer multiple of the unit wagered, in other implementations, the pay out award may be a fractional multiple of the unit wagered. That is, for each unit of value wagered, there may exist symbol combinations that result in a winning outcome of less that the amount of the unit risked, such as 0.6× the unit wagered. For example, in a gaming system where the unit wagered is $1, there may exist symbol combinations that result in a winning outcome of $0.60. Any fractional or integer multiple of a unit wagered may be used to define an individual combination award amount as long as the overall RTP of the gaming system does not exceed 100%.

As can be appreciated from the examples, both the hit rate frequency and the RTP of a reel strip set is dependent upon the distribution of symbols on the reel strips of a reel strip set and the defined symbol combination that produces a winning outcome of the game. However, in many implementations, the defined symbol combination that produces a winning outcome (e.g., the pay table) may be fixed in a pay table that may not be changed once determined. Thus, to vary the player experience with the gaming system in implementations where the pay table may not be adjusted during play, a gaming system may select and utilize a different reel strip set from a plurality of reel strip sets for a play of the game. As will be apparent, by providing a gaming system with varying reel strips, (e.g., by providing a gaming system with varying symbol sets) a variable win frequency gaming system may be created.

Returning to FIG. 3A, the game screen 300 depicts a plurality of symbol display areas 310a, 320a, 330a, 310b, 320b, 330b, 310c 320c, and 330c. In some implementations, the plurality of symbol display areas can be associated in a manner that provides the appearance of game reels. It should also be appreciated that the symbol display areas may not be associated with game reels in some implementations. As illustrated in FIG. 3A, symbol display areas 310a, 320a, 330a, 310b, 320b, 330b, 310c 320c, and 330c are associated in a manner that provides the appearance of three game reels. In one implementation, the plurality of symbol display areas that provide the appearance of three game reels may be arranged in a manner that visibly shows three symbol positions of each of the three game reels (or three reel strips). For example, the symbol display areas 310a-310c, 320a-320c, and 330a-330c are each associated with positions on reels 310, 320, and 330, respectively. As shown in FIG. 3A, symbol display areas 310a, 310b, and 310c are associated with reel 310; symbol display areas 320a, 320b, and 320c are associated with reel 320; symbol display areas 330a, 330b, and 330c are associated with reel 330. The arrangement illustrated in the implementation of FIG. 3A thus creates a visible display area of the reels strips 310, 320, and 330 comprising three fully visible symbol positions for each reel (310a, 310b, 310c, 320a, 320b, 320c, and 330a, 330b, 330c). When viewed together, reels 310, 320, and 330 appear like a 3-row by 3-column reel array in screen 300. In other implementations, smaller or larger visible areas of the reels can be displayed. That is, the reels 310, 320, and 330 may show fewer or a larger number of visible symbol display areas. While symbol display areas are illustrated with defined boxes, it should be appreciated that in some implementations, the defined boxes are not visible to the player.

Each reel 310, 320, and 330 may display a plurality of symbols that the gaming system generates from the set of symbols in their respective symbol display areas as illustrated in FIG. 3A. The symbols may be displayed in a manner to appear as though they are vertically descending from the upper positions 310a-330a through lower positions 310c -330c, respectively, such that they may form the appearance of symbols along the outer edge of spinning reels. However, it should be appreciated that the reels may be shown to appear to be spinning in any suitable direction. The reels may also be shown spinning in different directions, relative to each other, in some implementations.

To start a gaming session, a player provides the gaming system with a deposit of value, using one of the suitable mechanisms discussed above with respect to FIG. 1 and FIG. 2. The gaming system receives and validates the player's deposit of value. The gaming system can then issue credits (or gaming credits) to the player based on the received value. The credits enable the player to initiate a play of a game on the gaming system and to also place wagers on a play of the game on the gaming system. The gaming system may provide a visual indication of the player's credit balance to the player (not shown).

To initiate a play of a game, the player activates or presses one or more appropriate buttons on the gaming system to deduct credits necessary to play the game and to identify the player's wager. Along with receiving the player's wager, the gaming system may receive pay line selections or other game functions the player wishes to activate in exchange for the wager. The player may also actuate a game start button or a spin button. The gaming system may deduct the appropriate credits from the player's credit balance after the wager or at any suitable time.

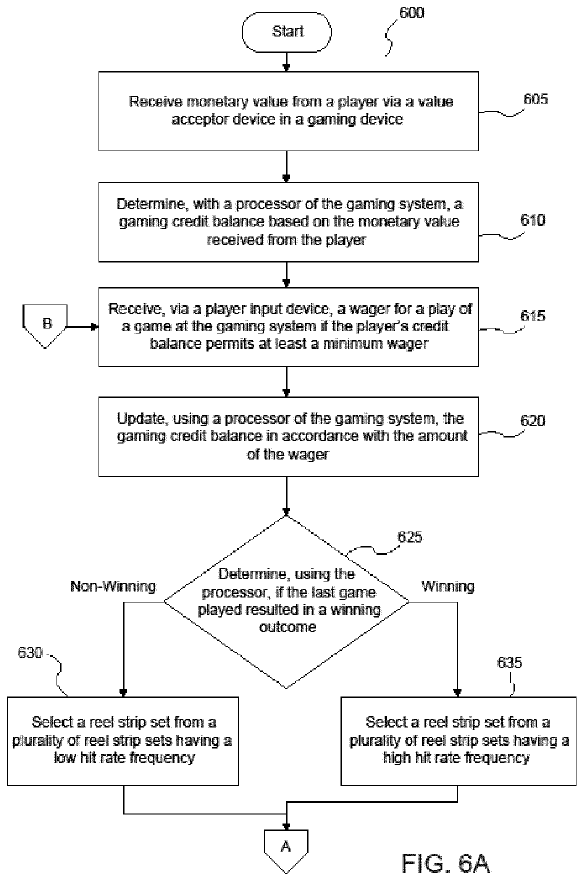

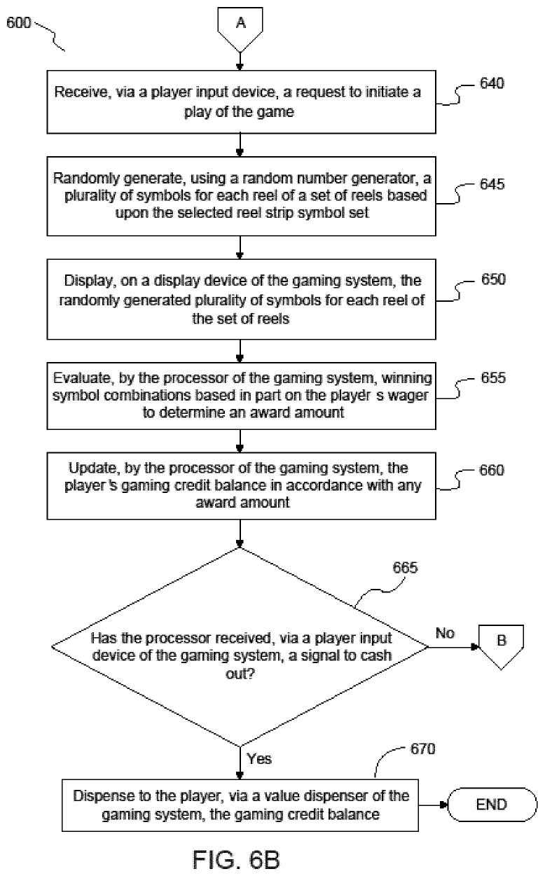

In one implementation, when a player initiates a play of a game by pressing one or more appropriate buttons on the gaming system, a processor of the gaming system selects a reel strip set (e.g., a reel strip for each reel of the game) from a plurality of reel strip sets. The method of operating the gaming system is more fully explained hereinbelow with respect to FIGS. 6A and 6B. In one implementation, the plurality of reel strip sets may be predetermined and stored in a memory of the gaming system. Upon receipt of the player's wager and activation of the game start button, the gaming system may show a display of spinning reels for each of the reels 310, 320, and 330. The spinning may appear to occur in a vertical top to bottom direction (not shown) or in a vertical bottom to top direction (not shown), or in a combination of vertical directions (not shown).

In one implementation, the gaming system randomly generates and displays symbols 315a, 325a, 335a, 315b, 325b, 335b, 315c, 325c, and 335c. The displayed symbols include a blank symbol in position 315a, a cherry symbol in position 325a, a grape symbol in position 335a, a 7 symbol in position 315b, a banana symbol in position 325b, a grape symbol in position 335b, a grape symbol in position 315c, a 7 symbol in position 325c, and a blank symbol in position 335c. In one implementation, the cherry symbol, grape symbol and banana symbol are all “fruit” symbols and have been defined as not creating a winning outcome when a combination of fruit symbols appear on a pay line that a player has placed a wager upon. A blank symbol has been defined as not creating a winning outcome when a combination including a blank symbol appears on a pay line that a player has placed a wager upon. The 7 symbol has been defined as creating a winning outcome when a combination of the 7 symbols appears as a winning outcome on a pay line that a player has placed a wager upon. It should be appreciated that various definitions of symbol combinations that create winning outcomes are possible and the implementations discussed herein are merely representative for ease of illustration. For example, in one implementation, a combination of the 7 symbol may be defined as creating a winning outcome of a high value while various combinations of the fruit symbols may be defined as creating a plurality winning outcomes of comparatively low values. In other implementations, fruit symbols may be associated with high values. The principles underlying the invention remain equally applicable regardless of the defined outcome values.

For each play of a game, the symbols are randomly generated (selected) by a processor of the gaming system from the associated reel strip set for reels 310, 320, and 330, respectively. The randomly selected symbols are then displayed. As noted above, the gaming system may rely on random generation performed by a pseudo RNG, a true RNG, or hardware RNG in making the random symbol selection.

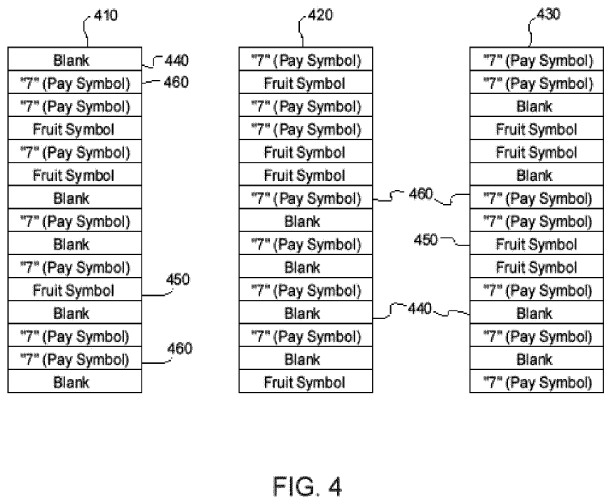

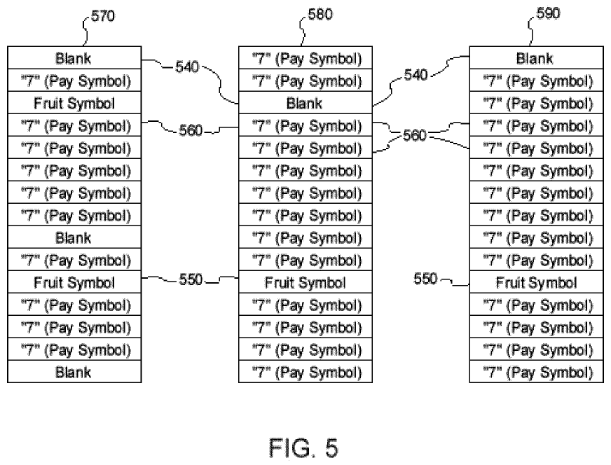

As a starting point for understanding the varying reel strips of the disclosure, a virtual reel strip symbol set utilized to randomly generate and display the symbols on screen 300 of FIG. 3A is depicted in FIG. 4. FIG. 4 is an illustration of one implementation of a reel strip set having a first hit rate frequency, wherein the first hit rate frequency has a lower hit rate frequency than a reel strip set depicted in FIG. 5. For purposes of illustration, reel strip 410 of FIG. 4 is associated with reel 310 of FIG. 3A, reel strip 420 of FIG. 4 is associated with reel 320 of FIG. 3A, and reel strip 430 of FIG. 4 is associated with reel 330 of FIG. 3A. Each reel strip includes blank symbols 440, fruit symbols 450, and pay symbols 460. The hit rate frequency of the reel strip set illustrated in FIG. 4 may be calculated as the total number of possible winning outcomes divided by the total number of possible symbol combinations. Each reel strip in FIG. 4 has 7 symbols (e.g., the “7” pay symbols) that may result in a winning outcome and 8 symbols that will not result in a winning outcome, resulting in 15 total symbols. Thus, the total number of possible winning outcomes is 7×7×7, or 343, and the total number of possible symbol combinations is 15×15×15, or 3375. The hit rate frequency in the example is 343/3375 or 0.1016 or 10.16%. This means that, on average, for every 100 games played on a gaming system utilizing this reel strip set, only an average of 10 will result in winning outcomes being generated.

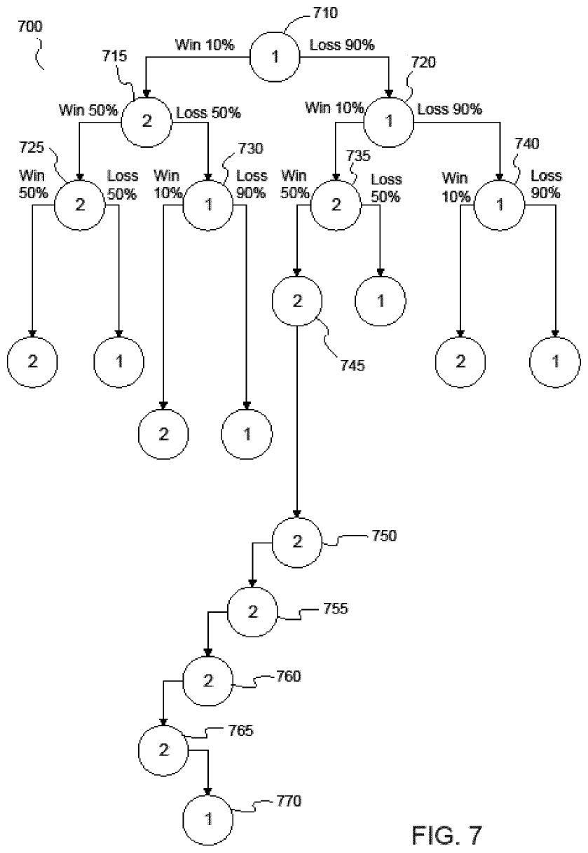

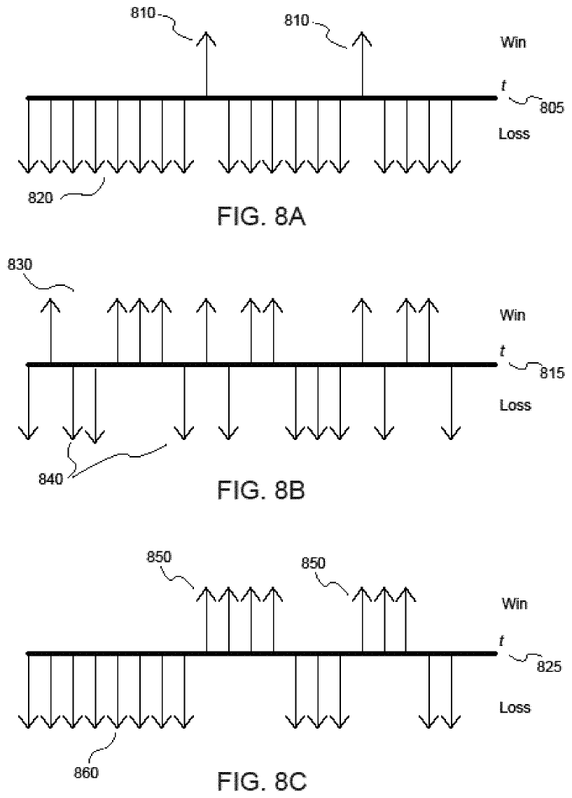

As can be appreciated, when the gaming system is selecting reel strip sets from a plurality of reel strip sets having a low hit rate frequency, a series of non-winning outcomes is likely to occur. This aspect is described more fully hereinbelow with respect to FIGS. 7 and FIG. 8A. However, because the symbols are randomly selected, winning outcomes will still occur. When a winning outcome occurs, in one implementation, the gaming system may vary the utilized symbol set and select a reel strip set from a plurality of reel strip sets having a high hit rate frequency for a play of a game, as illustrated in FIGS. 3B and 5.

FIG. 3B illustrates a screen shot of a next game played on the gaming system after a winning outcome is generated as described herein. In one implementation, after a winning outcome is generated on the gaming system, the system may select a reel strip set from a plurality of reel strip sets having a high hit rate frequency. In one such implementation, the gaming system varies the reel strip symbol set by selecting a new reel strip set having symbols associated therewith that provide a higher hit rate frequency value than a reel strip set utilized by the gaming system after a non-winning outcome is generated. In this manner, the probability of the next game resulting in a winning outcome is enhanced.

In FIG. 3B, the game screen 300 depicts a plurality of symbol display areas 370a, 380a, 390a, 370b, 380b, 390b, 370c, 380c and 390c. The symbol display areas can be associated in a manner that provides the appearance of game reels, as described above with reference to FIG. 3A. It should also be appreciated that the symbol display areas may not be associated with game reels in some implementations. As illustrated in FIG. 3B, symbol display areas 370a, 380a, 390a, 370b, 380b, 390b, 370c, 380c, and 390c are associated in a manner that provides the appearance of a set of three game reels 370, 380, and 390. In one implementation, the plurality of symbol display areas that provide the appearance of three game reels may be arranged in a manner that visibly shows three symbol positions of each of the three game reels. For example, the symbol display areas 370a-370c, 380a-380c, and 390a-390c are each associated with positions on reels 370, 380, and 390, respectively. As shown in FIG. 3B, symbol display areas 370a, 370b, and 370c are associated with reel 370; symbol display areas 380a, 380b, and 380c are associated with reel 380; and symbol display areas 390a, 390b, and 390c are associated with reel 390. The arrangement illustrated in the implementation of FIG. 3B thus creates a visible display area of the reels 370, 380, and 390 comprising three fully visible symbol positions for each reel. When viewed together, reels 370, 380, and 390 appear like a 3-row by 3-column reel array in screen 300. In other implementations, smaller or larger visible areas of the reels can be displayed. That is, the reels 370, 380, and 390 may show fewer or a larger number of visible symbol display areas. While symbol display areas are illustrated with defined boxes, it should be appreciated that in some implementations, the defined boxes are not visible to the player or there are no defined boxes.

Each reel 370, 380, and 390 may display a plurality of symbols that the gaming system generates from the set of symbols in their respective symbol display areas as illustrated in FIG. 3B. The symbols may be displayed in a manner to appear as though they are vertically descending from the upper positions 370a-390a through lower positions 370c-390c, respectively such that they form the appearance of symbols along the outer edge of spinning reels. However, it should be appreciated that the reels may be shown spinning in any suitable direction. The reels may also be shown spinning in different directions in some implementations.

To initiate a next play of a game on the gaming system after a winning outcome is generated, the player activates or presses one or more appropriate buttons on the gaming system to deduct credits necessary to play the game and to identify the player's wager. Along with receiving the player's wager, the gaming system may receive pay line selections or other game functions the player wishes to activate in exchange for the wager. The player may also actuate a game start button or a spin button. The gaming system may deduct the appropriate credits from the player's credit balance after the wager or at any suitable time.

In one implementation, when a player initiates a subsequent play of the game (after a winning outcome is generated) by pressing one or more appropriate buttons on the gaming system, a processor of the gaming system selects a reel strip set (e.g., a reel strip for each reel of the game) from a plurality of reel strip sets. The method of operating the gaming system is more fully explained hereinbelow with respect to FIGS. 6A and 6B. In one implementation, the plurality of reel strip sets may be predetermined and stored in a memory of the gaming system. Upon receipt of the player's wager and activation of the game start button, the gaming system may show a display of spinning reels for each of the reels 370, 380, and 390. The spinning may appear to occur in a vertical top to bottom direction (not shown) or in a vertical bottom to top direction (not shown), or in a combination of vertical directions (not shown).

In one implementation, the gaming system randomly generates and displays symbols 375a, 385a, 395a, 375b, 385b, 395b, 375c, 385c, and 395c. The displayed symbols include a blank symbol in position 375a, a 7 symbol in position 385a, a grape symbol in position 395a, a 7 symbol in position 375b, a 7 symbol in position 385b, a 7 symbol in position 395b, a 7 symbol in position 375c, a cherry (fruit) symbol in position 385c, and a 7 symbol in position 395c. In one implementation, the cherry symbol, grape symbol, and banana symbol (not shown) are all “fruit” symbols and have been defined as not creating a winning outcome when a combination of fruit symbols appear on a pay line that a player has placed a wager upon. A blank symbol has been defined as not creating a winning outcome when a combination including a blank symbol appears on a pay line that a player has placed a wager upon. The 7 symbol has been defined as creating a winning outcome when a combination of the 7 symbols appear as a winning outcome on a pay line that a player has placed a wager upon. It should be appreciated that various definitions of symbol combinations that create winning outcomes are possible and the implementations discussed herein are merely representative for ease of illustration. For example, as explained above in one implementation, a combination of the 7 symbol may be defined as creating a winning outcome of a high value while various combinations of the fruit symbols may be defined as creating a plurality winning outcomes of comparatively low values. The principles underlying the invention remain equally applicable regardless of the defined outcome values.

The displayed symbols illustrated in FIG. 3B are randomly selected from a different reel strip set than the displayed symbols illustrated in FIG. 3A. The symbols for reels 370, 380, and 390 in FIG. 3B are selected from reel strip sets having a higher hit rate frequency than the reel strip sets utilized for reels 310, 320, and 330, respectively. As noted above, the gaming system may rely on random generation performed by a pseudo RNG, a true RNG, or hardware RNG when selecting the symbols from the reel strips of the reel strip symbol set.

The reel strip set utilized to randomly generate and display the symbols on screen 300 of FIG. 3B is depicted in FIG. 5. FIG. 5 is an illustration of one implementation of a reel strip set having a second hit rate frequency, wherein the second hit rate frequency is a higher hit rate frequency than a reel strip set depicted in FIG. 4. Reel strip 570 of FIG. 5 is associated with reel 370 of FIG. 3B, reel strip 580 of FIG. 5 is associated with reel 380 of FIG. 3B, and reel strip 590 of FIG. 5 is associated with reel 390 of FIG. 3B. Each reel strip includes blank symbols 540, fruit symbols 550, and pay symbols 560. The hit rate frequency of the reel strip set illustrated in FIG. 5 may be calculated as the total number of possible winning outcomes divided by the total number of possible symbol combinations. Reel strip 570 has 10 symbols which may result in a winning outcome and 5 symbols which may not result in a winning outcome. Reel strip 580 has 13 symbols which may result in a winning outcome and 2 symbols which may not result in a winning outcome. Reel strip 590 has 13 symbols which may result in a winning outcome and 2 symbols which may not result in a winning outcome. Each reel strip in FIG. 5 has 15 total symbols. Thus, the total number of possible winning outcomes is 10×13×13, or 1690, and the total number of possible symbol combinations is 15×15×15, or 3375. The hit rate frequency in the example is 1690/3375 or 0.5007 or 50.07%. This means that, on average, for every 100 games played on a gaming system utilizing this reel strip set, an average of 50 will result in winning outcomes being generated.

As can be appreciated, when the gaming system selects a reel strip set from a plurality of reel strip sets having a high hit rate frequency, it is more likely that the gaming system will generate a winning outcome. When the gaming system sequentially selects back to back reel strip sets having a high hit rate frequency, the gaming system is more likely to generate a series of winning outcomes. A series of winning outcomes may greatly increase the player's excitement. This aspect is described more fully hereinbelow with respect to FIG. 7 and FIG. 8B.

It should be appreciated that the payout amounts associated with winning outcome symbol combinations (e.g., the pay table) may be selected such that a set of reel strips having a low hit rate frequency and a set of reel strips having a high hit rate frequency may have an identical or substantially similar RTP value. In one implementation, the gaming system and method utilizes reel strip sets (both low and high value reel strip sets) created such that the overall RTP amount for any particular gaming system remains constant, or substantially constant (e.g., within a designated predetermined range of return to player amounts) during a plurality of plays of a game. In this manner, the gaming system's overall RTP value remains certain even though a plurality of reel strip sets having different hit rate frequency values are utilized during play of a series of games.

FIGS. 6A and 6B illustrate a flowchart of an example operation 600 of one implementation of the gaming system and method having variable symbol sets for variable win frequency gaming. In one implementation, a processor is configured, via instructions stored in a memory device, to perform the operation 600. However, it should be appreciated that other suitable variations of operation 600 are possible. For example, in one implementation, fewer or one or more additional blocks (not shown) may be employed in operation 600 of the gaming system and method. In other implementations, the blocks may be performed in any suitable order.

FIG. 6A illustrates one implementation in which the gaming system receives a monetary value from a player to initiate operation 600. As indicated in block 605, the gaming system may receive monetary value via a value acceptor device associated with the gaming system. The value acceptor device may be, in one implementation, disposed in a gaming device of the gaming system or in communication with the gaming device as discussed above.

In one implementation, the gaming system may determine a credit balance based on the monetary value received from the player at a value acceptor device as indicated in block 610. The gaming system may determine, via a processor, a gaming credit balance for the player. The gaming credit balance may be based on the monetary value received from the player at the value acceptor device.

In one implementation, the gaming system may receive a wager for a play of a game at the gaming device. Block 615 of FIG. 6A illustrates one implementation where the player's wager may be received via a player input device. The gaming device may allow a player to place a minimum wager, a maximum wager, or any suitable wager amount. Depending on the wager amount, the gaming device may also enable the player to select pay lines across displayed symbol positions on reels in a game. In one implementation, the gaming system may determine whether the player credit balance is large enough to enable the player's selected wager. The gaming system may prevent the player from placing the wager and starting a play of a game if the player's credit balance is not large enough to support the player's selected wager. If enough credits are not available in the player's credit balance, the gaming system enables the player to insert additional value to obtain the minimum credit level or to cash out of the gaming device.

In one implementation, the gaming system may use a processor of the gaming device to update a gaming credit balance. The credit balance may be updated in accordance with the player's wager amount as indicated in block 620. Some implementations, the credit balance is not updated until a later time.

Block 625 illustrates one implementation in which the gaming system may determine, using a processor, an outcome status of the last game played on the gaming system. For example, the processor may determine whether the last game played on the gaming system resulted in a non-winning outcome or whether the last game played on the gaming system resulted in a winning outcome. In one implementation, the outcome of the last game played may be utilized to determine the selection, by a processor of the gaming system, of a reel strip set from a plurality of reel strip sets to be used in the current game. In this manner, the outcome of a current game under play may be determined, at least in part, based upon the outcome of the previous game played. It should be appreciated that a winning outcome, in one implementation, may include outcomes resulting in any amount of award or value being returned to the player. The award or value being returned to the player may include: symbol combination pays, monetary awards, a quantity of free games, a bonus game, a reel or symbol nudge, a quantity of reel re-spins, or any other suitable award or value being returned to the player. In one implementation, a winning outcome may include outcomes resulting in a predetermined amount or greater of award or value being returned to the player. Thus, in one implementation, a non-winning outcome may include outcomes resulting in less than a predetermined amount of award or value being returned to a player.

Reel strips are generally discussed above with reference to FIGS. 3A, 3B, 4, and 5. As discussed above, a reel strip set defines the symbols and symbol distribution utilized in a play of a video reel wagering game. For example, in a three-reel gaming system implementation, each reel strip set of the plurality of reel strip sets includes at least three symbol sets (e.g., one symbol set for each reel.) or three reel strips. In a like manner, in a five-reel gaming system implementation, each reel strip set of the plurality of reel strip sets includes at least five symbol sets (e.g., one symbol set for each reel) or five reel strips. Thus, in one implementation, a reel strip set contains a reel strip, or set of symbols, for each reel of the wagering game. However, it should be appreciated that in other implementations, a reel strip set may contain more reel strips than reels of the wagering game. In these implementations, a reel strip may be randomly selected from the reel strip set for each reel of the wagering game. It should also be appreciated that reel strips are used merely for illustration purposes throughout this disclosure. In some implementations, predetermined reels strips may be used. In other implementations, a reel strip is a representation of a set of symbols, where each of the symbols in the set of symbols is associated with a probability of being generated for display in the visible symbol display areas of the virtual reels. In some such implementations, an actual or physical reel strip is not used in the game.

Reel strips (and reel strip sets) may be described and categorized by mathematical statistics, as generally discussed above with reference to FIGS. 3A, 3B, 4 and 5. Reel strip and reel strip set statistics may include a return to player percentage or RTP. Generally, the RTP percentage represents the theoretical payout percentage, or the return to player, of a gaming system. The RTP percentage describes the expected ratio of money paid out to money wagered of a gaming system. For example, a RTP value of 92.8% means that over many plays of a gaming system utilizing a particular reel strip set, an average of $92.80 will be paid out for every $100 wagered on the gaming system. In a like manner, a RTP value of 86% means that over many plays of a gaming system utilizing a particular reel strip set, an average of $86 will be paid out for every $100 wager on the gaming system. RTP may be considered as a statistical characteristic of a reel strip set.

In one implementation, each reel strip of each reel strip set of the plurality of reel strip sets may be predetermined or generated in a manner so that each reel strip set provides the same theoretical RTP value. For example, in one implementation, the theoretical RTP value of each reel strip set contained in the plurality of reel strip sets may be 96%. A reel strip set RTP value of 96% means that over many plays of a gaming system utilizing the reel strip sets contained in the first plurality of reel strip sets, an average of $96 will be paid out for every $100 wagered on the gaming system. In other implementations, the plurality of reel strip sets may be predetermined or generated in a manner so that the reel strip sets may have minor variances in the RTP value. For example, in one implementation some of the reel strip sets of the plurality of reel strip sets may have RTP values of 96.1% and other reel strip sets may have RTP values of 96.01%. In yet other implementations, the plurality of reel strip sets may be predetermined or generated over a narrow range of RTP values. For example, in one implementation, the plurality of reel strip sets may have statistical RTP values ranging from 95.9% to 96.1%. It should be appreciated that the range of RTP variance across the plurality of reel strip sets may be larger or smaller than the example illustrated.

Reel strip and reel strip set statistics utilized to describe and categorize reel strips may further include a hit rate frequency value, generally discussed above with reference to FIGS. 3A, 3B, 4, and 5. Each reel strip set may have a statistical measurement of the risk associated with a play of a game on a gaming system utilizing the reel strip set. The measurement of the risk associated with a play of a game will be referred to herein as “hit rate frequency.” Hit rate frequency is the theoretical percentage of game reel spins that will result in a winning outcome and payout to the player. Stated differently, hit rate frequency indicates, on average over many plays of the gaming system, how many games have a non-winning outcome as compared to how many games have a winning outcome.

In one implementation, the hit rate frequency of a gaming system is based at least in part upon the number of symbols contained on the reel strips utilized in the gaming system and the definition of a winning outcome as defined by the symbol combinations found in a pay table associated with the gaming system. In one implementation, gaming systems utilizing reel strip sets having low hit frequencies may generate winning outcomes for a player less frequently. In one implementation, gaming systems utilizing reel strip sets having high hit frequencies may generate winning outcomes for a player more frequently.

Returning to process flow 600 of FIG. 6A and blocks 630 and 635, in one implementation, the gaming system operates each play of a game based upon a reel strip set that may be selected from either a first plurality of reel strip sets (block 630) or a second plurality of reel strip sets (block 635). It should be appreciated that the gaming system may also use additional different plurality of reel strip sets in some implementations. Process flow 600 utilizing the second plurality of reel strip sets in relation to block 635 is described more fully hereinbelow. In process block 630, a first plurality of reel strip sets may contain reel strips having a low hit rate frequency when compared to a second plurality of reel strip sets. In one implementation, the hit rate frequency of a first plurality of reel strip sets may be 10%. A hit rate frequency of 10% means that over many plays of a gaming system utilizing the reel strips contained in the first plurality of reel strip sets, an average of ten out of every one hundred plays of a game on the gaming system will generate a winning outcome.

Continuing with process flow 600 of FIG. 6A and block 630, in one implementation, when a processor of the gaming system determines that the last game played resulted in a non-winning outcome, the processor may select a reel strip set from a first plurality of reel strip sets having a low hit rate frequency. In one implementation, a processor may select a reel strip set from a first plurality of reel strip sets having a hit rate frequency of 10%, or a 1 in 10 chance that the play of the game will result in a winning outcome. In one implementation, the processor of the gaming system, in block 630, may randomly select a reel strip set from a first plurality of reel strip sets associated with a low hit rate frequency. In one implementation, the processor of the gaming system, in block 630, may sequentially select a reel strip set from the first plurality of reel strip sets having a low hit rate frequency. In some implementations, the first plurality of reel strip sets associated with a low hit rate frequency may be predetermined reel strips. In other implementations, the first plurality of reel strip sets associated with a low hit rate frequency may be randomly generated according to predetermined symbol sets, hit rate frequency constraints, and return to player value constraints. Once the reel strip set has been selected, off page connector A refers to FIG. 6B to continue operation 600.

Turning now to FIG. 6B and off page connector A, block 640 illustrates one implementation in which the gaming system may receive a request to initiate a play of a game. The request to initiate the play of the game at the gaming system may be received from a player via a player input device in communication with the gaming system. For example, the player may press a spin button on the gaming system to start the spinning reels (or randomly generating symbols using other methods discussed above) for the play of the game.

In one implementation, the gaming system may use a random number generator to randomly generate a plurality of symbols from a set of symbols based upon the reel strip set selected in block 630, as indicated in block 645. In some implementations, the gaming system may generate the plurality of symbols for display on a set of reels in accordance with the reel strip set selected in block 630. As used herein, the random number generation may refer to pseudo-random or true-random number generation depending on the module used for the random number generation.

In one implementation, the gaming system may cause a display device of the gaming system to display the plurality of symbols randomly generated from the selected reel strip set as indicated in block 650. In one implementation, the gaming system may cause a video display device to display the plurality of symbols randomly generated in a manner as discussed above in relation to FIG. 3A. In one implementation of a gaming system using physical reels fitted with video display technology, the gaming system may display the generated plurality of symbols in visible symbol display areas on each of the reels.

In one implementation as shown in block 655, the gaming system evaluates the generated plurality of symbols across wagered pay lines for winning symbol combinations. In some implementations, the gaming system evaluates the winning symbol combinations based on the pay lines wagered upon by a player. The gaming system may evaluate the player selected pay lines or default pay lines assigned for the play of the game. In one implementation where the game uses reels, the gaming system determines an award amount based on winning symbol combinations formed across the reels on active (wagered upon) pay lines. For example, if a pay table associated with the gaming system indicated that at least three of the same “7” symbols is a winning symbol combination and awards a predetermined payout, the gaming system would evaluate the generated plurality of symbols for “7” symbols. If at least three “7” symbols were generated on adjacent reels and along a pay line, the gaming system may determine that the three “7” symbols are a winning symbol combination based on the predetermined pay table. For example, in the implementation illustrated in FIG. 3B, the gaming system may evaluate the pay line 360 and determine that the three “7” symbols across symbol positions 370b, 380b, and 390b are a winning symbol combination based on the predetermined pay table. It should be appreciated that a pay table may include any suitable number of winning symbol combinations and payouts. In one implementation, a pay table may indicate that as few as one symbol may be associated with a payout. Alternatively, two or more symbols may be used to form winning symbol combinations that result in a payout.

At block 660, the gaming system may update, with the processor, player's gaming credit balance in accordance with any award amount determined by the evaluation. As noted above, the blocks illustrated in FIGS. 6A-6B can be rearranged in any suitable order. As such, it should be appreciated that the gaming system may update the player's gaming credit balance at other suitable times.

In one implementation, as indicated in block 665, the gaming system may receive a signal to end game play or “cash out” via an input device of the gaming system. In such a situation, the gaming system dispenses a value to the player, through a value dispenser, based on the player's gaming credit balance as illustrated in block 670 and operation 600 ends.

On the other hand, if the gaming system processor has not received a signal to end game play via the player input device, the process of operation 600 returns to block 615 via off page connector B. The gaming system may receive, via a player input device, a wager for another play of the game and continue operation 600 from block 615. However, in one implementation, the wager may not be accepted if the player has fewer credits than the player's selected wager amount as shown in block 615.

Process flow 600 will now be described with the assumption that the previous game played on the gaming system resulted in a winning outcome.

During a next play of the game, the gaming system may use a processor of the gaming device to update a gaming credit balance. The credit balance may be updated in accordance with the player's wager amount as indicated in block 620. Some implementations, the credit balance is not updated until a later time.

Block 625 illustrates one implementation in which the gaming system may determine, using the processor, whether the last game played on the gaming system resulted in a non-winning outcome or whether the last game played on the gaming system resulted in a winning outcome. For discussion purposes, the last game played on the gaming system resulted in a winning outcome and process 600 moves to block 635.

Block 635 illustrates an implementation in which a processor of the gaming system may randomly select a reel strip set from a second plurality of reel strip sets having a higher hit rate frequency than the hit rate frequency of the first plurality of reel strip sets associated with block 630 discussed above. In one implementation, the processor of the gaming system, in block 635, may sequentially select a reel strip set from a second plurality of reel strip sets having a high hit rate frequency. In other implementations, the processor of the gaming system, in block 635, may randomly select a reel strip set from a second plurality of reel strips sets having a high hit rate frequency.

In one implementation, the hit rate frequency of a second plurality of reel strip sets may be 50%. A hit rate frequency of 50% means that over many plays of a gaming system utilizing the reel strip sets contained in the second plurality of reel strip sets, an average of fifty out of every one hundred plays of the game, the gaming system will generate a winning outcome. It should be appreciated that the hit rate frequency of 50% is merely for illustration purposes and any suitable hit rate frequency may be used.

It should be appreciated that the hit rate frequency percentages for both the first and second plurality of reel strip sets (10% and 50%, respectively) may be varied and may be higher or lower than the disclosed implementations. It should be appreciated that in some implementations, the gaming system may use more than two pluralities of reel strip sets. It should also be appreciated that in some implementations, each reel strip set may include any suitable quantity of reel strips.

In some implementations, the second plurality of reel strip sets having a high hit rate frequency may be predetermined reel strips. In other implementations, the second plurality of reel strip sets having a high hit rate frequency may be randomly generated according to predetermined symbol sets, hit rate frequency constraints, and return to player value constraints. Once the gaming system selects the reel strip set, off page connector A refers to FIG. 6B to continue operation 600.

Turning now to FIG. 6B and off page connector A, block 640 illustrates one implementation in which the gaming system may receive a request to initiate a play of a game. The request to initiate the play of the game on the gaming system may be received from a player via a player input device in communication with the gaming system. For example, the player may press a spin button on the gaming system to start the spinning reels (or randomly generating symbols using other methods discussed above) for the play of the game.

In one implementation, the process flow 600 may continue from this point through blocks 645 to block 665 or 670 in the same manner previously described.

As can be appreciated, when a player achieves a non-winning outcome on a play of a game on the gaming system, there is a low probability the next game will result in a winning outcome. In one such implementation, there is a 1 in 10 chance that a winning outcome will be generated on the next game because the gaming system will select the next reel strip set from the first plurality of reel strip sets having a low hit rate frequency (e.g., 10%). However, when a player achieves a winning outcome on a gaming system utilizing reel strips selected from a first plurality of reel strip sets having a low hit rate frequency, a subsequent play of the game causes the gaming system to utilize reel strip sets selected from a second plurality of reel strip sets having a high hit rate frequency. In one implementation, the second plurality of reel strips sets have a hit rate frequency of 50% meaning there is a 5 out of 10 chance that a winning outcome will be generate on the next game. When the gaming system selects a reel strip set from the second plurality of reel strip sets having a high hit rate frequency, the gaming system is more likely to produce another winning outcome (because of the repetitive selection of a reel strip set having a high hit rate frequency) and to continue to produce winning outcomes. In time, however, the gaming system will generate a non-winning outcome. After a non-winning outcome is generated in a game using the high hit rate frequency reel strip set, the gaming system may select a reel strip set from the first plurality of reel strip sets having a low hit rate frequency for the next game. By varying the reel strips, which is to say by varying the game symbol sets, in this manner, the gaming system and method is more likely to produce a group or series of wins for a player. In this manner, player excitement and anticipation of the gaming system entering a “winning streak” or a “hot” status producing winning outcomes is greatly enhanced.

FIG. 7 is a graphical representation of a decision tree representation 700 of one implementation of the gaming system and method of varying symbol sets for variable win frequency in a gaming system. In FIG. 7, each decision tree node represents a gaming outcome decision point (e.g., a play of a game on the gaming system). Game outcomes are represented by decision tree node branches. Decision tree node branches lead to the next game's outcome decision node. The probability of an outcome, in one implementation, is indicated along certain decision tree node branches and is associated with the hit rate frequency of the reel strip sets utilized in outcome determination. For example, the numeral “1” in a decision tree node indicates that the gaming system selected a reel strip set from a first plurality of reel strip sets having a low hit rate frequency. A decision tree node having the numeral “1” also indicates that the game immediately prior to the decision tree node resulted in a non-winning outcome decision. In a like manner, the numeral “2” in a decision tree node indicates that the gaming system selected a reel strip set from a second plurality of reel strip sets having a high hit rate frequency, and that the game immediately prior to the decision tree node resulted in a winning outcome. In this manner, a randomly determined decisional outcome at any node affects the probability of a randomly determined decisional outcome and the next node. While hit rate frequency for the low hit rate frequency sets are shown at 10% and the high hit rate frequency sets are shown at 50%, any suitable hit rate frequencies may be used.

In one implementation illustrated in FIG. 7, there are two possible decision tree outcomes at a decision tree node (e.g., the two possible outcomes of a particular game under play): a winning outcome (win) and a non-winning outcome (loss). Decision flows of non-winning outcomes will be described first followed by a description of decision flows of winning outcomes. The order is solely for ease of illustration.

Turning to FIG. 7 and decision tree entry node 710, the gaming system may select a reel strip set from a first plurality of reel strip sets having a low hit rate frequency as illustrated at 710. The numeral “1” in the decision tree node at 710 indicates that the gaming system selected a reel strip set from a first plurality of reel strip sets having a low hit rate frequency. It should be appreciated that in some implementations, the first game played on a gaming system (system initialization) may default to using a reel strip set having a low hit rate frequency. In some implementations, the gaming system may default to selecting a reel strip having a low hit rate frequency after the gaming system has been idle for a predetermined period.

In one implementation, decision tree node 710 represents that the gaming system selected a reel strip set from a first plurality of reel strip sets having a low hit rate frequency and executed a play of a game. The gaming system displayed and evaluated the randomly generated symbols from the selected reel strip set. Because the gaming system used a low hit rate frequency reel strip set for the player of the game, the gaming system likely generated a non-winning outcome. This is because games played using a reel strip set having a low hit rate frequency result in a winning outcome in only 10% of game plays. Thus, a non-winning outcome occurs on a statistical frequency of 90% of game plays. This is indicated on FIG. 7 as “win 10%” and “loss 90%” on the decision tree node branches surrounding node 710. As noted above, the decision tree node branches illustrate the two possible outcomes of a play of a game on the gaming system. It should also be appreciated that the gaming system may have generated a winning outcome too.

Decision tree node 720 represents the decisional aspects of the next play of the game after the gaming system generated a non-winning outcome at decision tree node 710. As explained in relation to blocks 625 and 630 of FIG. 6A, the gaming system may select a reel strip set from a plurality of reel strip sets having a low hit rate frequency when the previous game play resulted in a non-winning outcome. This is represented by the numeral “1” in decision tree node 720. In a similar manner as described above with respect to decision tree node 710, and for the same reasoning, it is 90% likely that a non-winning outcome occurred as a result of the game play represented by decision tree node 720. When a non-winning outcome occurs, decision tree flow proceeds to decision tree node 740.

Decision tree node 740 represents the decisional aspects of the next game played after the gaming system generated a non-winning outcome at decision tree node 720. At 740, the numeral “1” in the decision tree node at 740 indicates that, as above, the gaming system selected a reel strip set from a plurality of reel strip sets having a low hit rate frequency. In a similar manner as described above with respect to decision tree nodes 710 and 720, and for the same reasoning, in one implementation it is 90% likely that a non-winning outcome occurred as a result of the game play represented by decision tree node 740.

It should be appreciated that game outcomes determined utilizing reel strip sets selected from the first plurality of reel strip sets (e.g., a “1” decision tree node) are more likely to result in a series of non-winning game outcomes than game outcomes determined utilizing reel strip sets selected from the second plurality of reel strip sets. In one implementation, the series of games resulting in non-winning game outcomes may be lengthy. However, winning outcomes may occur, as indicated by decision tree flow to nodes 715, 725, and 735-765 of FIG. 7. Decision tree flow will now be described when a game outcome evaluation results in a winning outcome.

In one implementation, the gaming system generated a winning outcome at decision tree node 710. The decision tree branch leads to decision tree node 715. Decision tree node 715 indicates that, in accordance with the process as explained in blocks 625 and 635 of FIG. 6A, the gaming system selected a reel strip set from a plurality of reel strip sets having a high hit rate frequency. This is indicated by the numeral “2” in the decision tree node 715. Stated differently, in one implementation, the gaming system stopped selecting reel strip sets from the first plurality of reel strip sets having a low hit rate frequency and selected reel strip sets from a second plurality of reel strip sets having a high hit rate frequency because of the prior winning outcome.

At decision tree node 715, it is equally likely that a winning outcome was generated after the gaming system displayed and evaluated the randomly generated symbols from the selected reel strip set. This is because games played using a reel strip set having a high hit rate frequency result in a winning outcome in 50% of game plays. Thus, a winning outcome occurs on a statistical frequency of 50% of game plays. This is indicated on FIG. 7 as “win 50%” and “loss 50%” on the decision tree node branches surrounding node 715. As noted above, the decision tree node branches illustrate the two possible outcomes of a play of a game on the gaming system.

Decision tree node 730 represents the decisional aspects of the next game played after the gaming system generated a non-winning outcome at decision tree node 715. As explained in relation to blocks 625 and 630 of FIG. 6A, the gaming system may select a reel strip set from a plurality of reel strip sets having a low hit rate frequency when the previous game play resulted in a non-winning outcome. This is represented by the numeral “1” in decision tree node 730. In a similar manner as described above with respect to decision tree node 720, and for the same reasoning, it is 90% likely that the gaming system generated a non-winning outcome at decision tree node 730. When a non-winning outcome is generated, decision tree flow proceeds in a like manner as described above.

However, in one implementation, it is equally likely that the gaming system generated a winning outcome at decision tree node 715. Decision tree node 725 represents the decisional aspects of the next game played after the gaming system generated a winning outcome the game of decision tree node 715. Decision tree node 725 indicates that, in accordance with the process as explained in blocks 625 and 635 of FIG. 6A, the gaming system selected a reel strip set from a plurality of reel strip sets having a high hit rate frequency when the previous game play resulted in a winning outcome. This is indicated by the numeral “2” in the decision tree node 725. The gaming system selected a reel strip set from a second plurality of sets of reel strip sets having a high hit rate frequency for a play of the game. It should be appreciated that game outcomes determined utilizing reel strip sets selected from the second plurality of reel strip sets (e.g., a “2” decision tree node) are more likely to result in a series of winning game outcomes than game outcomes determined utilizing reel strip sets selected from the first plurality of reel strips. In this manner, a series of winning outcomes may be generated (not shown) and increase the excitement for the player.

At decision tree node 720, there is a 10% probability that the gaming system generated a winning outcome. When a winning outcome is generated at decision tree node 720, the decision tree branch leads to decision tree node 735. Decision tree node 735 represents the decisional aspects of the next game played after a winning outcome is generated at the game of decision tree node 720. Decision tree node 735 indicates that, in accordance with the process as explained in blocks 625 and 635 of FIG. 6A, the gaming system selected a reel strip set from a plurality of reel strip sets having a high hit rate frequency. This is indicated by the numeral “2” in the decision tree node 735. The gaming system selected a reel strip set from a second plurality of sets of reel strip sets having a high hit rate frequency for a play of the game. As can be appreciated, in one implementation, game outcomes determined utilizing reel strip sets selected from the second plurality of reel strip sets (e.g., a “2” decision tree node) are more likely to result in a series of winning game outcomes than game outcomes determined utilizing reel strip sets selected from the first plurality of reel strip sets. In this manner, a series of winning outcomes may be generated. In one implementation, a series of winning outcomes are illustrated by decision tree nodes 745, 750, 755, 760, and 765. Each of the decision tree nodes 745, 750, 755, 760, and 765 contains the numeral “2”, which, as described above, indicates that the gaming system selected a reel strip set from the second plurality of reel strip sets having a higher hit rate frequency. The numeral “2” also indicates that the game immediately prior to the respective node resulted in a winning outcome. The group or series of games with winning outcomes illustrated by decision tree nodes 745, 750, 755, 760, and 765 ends at decision tree node 765 where the gaming system generated a non-winning outcome.

As can be appreciated in the implementation illustrated, while the gaming system generates non-winning game outcomes, the gaming system continues to select reel strip sets from the first plurality of reel strip sets having a low hit rate frequency until the gaming system generates a winning outcome. When a winning outcome is generated, the gaming system may select reel strip sets from the second plurality of reel strip sets having a high hit rate frequency. The gaming system will continue plays of the game by selecting reel strip sets from the second plurality of reel strip sets having the high hit rate frequency until a non-winning outcome is generated. After a non-winning outcome is generated, the gaming system may revert to selecting reel strip sets from the first plurality of reel strip sets having a low hit rate frequency. In this manner, the low hit rate frequency of the first plurality of reel strip sets may result in the creation of a random distribution of non-winning outcomes for the player. However, once a winning outcome is generated, the higher hit rate frequency of the second plurality of reel strip sets may result in the creation of a cluster or group of winning outcomes for the player that was not previously available to players. Players may come to recognize that a winning outcome may signify a winning streak or a “hot” status is possible, thereby increasing player anticipation and excitement. The game as disclosed herein also creates a long winning experience for players that was not previously available.

FIGS. 8A, 8B and 8C are graphical representation of timelines illustrating game outcomes over time on games played utilizing reel strips having different hit rate frequencies. FIG. 8C further illustrates the group or cluster effect of using reel strip sets with different hit rate frequencies for variable win frequencies for one implementation of the disclosure. In FIGS. 8A, 8B, and 8C, winning outcomes of plays of a game on the gaming system are indicated by arrows pointing upward above the timeline t and non-winning outcomes are indicated by arrows pointing downward below timeline t.

FIG. 8A illustrates a representative series of 20 plays on a gaming system utilizing only reel strip sets selected from the first plurality of reel strip sets discussed above, having a low hit rate frequency. In one implementation, the hit rate frequency of a first plurality of reel strip sets may be 10%. A hit rate frequency of 10% means that over many plays of a game utilizing the reel strip sets contained in the first plurality of reel strip sets, an average of ten out of every one hundred plays of the game will generate a winning outcome. Scaled for illustration, a hit rate frequency of 10% may be represented as two winning outcomes or wins 810 and 18 non-winning outcomes or losses 820 distributed along timeline 805. Viewed in this manner, it can be appreciated that in a gaming system utilizing reel strips having a hit rate frequency of 10%, the gaming system may generate a lengthy series of non-winning outcomes broken by an occasional winning outcome (or two). The long length of time between winning outcomes may not be satisfactory to players.

FIG. 8B illustrates a representative series of 20 plays on a gaming system utilizing only reel strip sets selected from the second plurality of reel strip sets having a high hit rate frequency. In one implementation, a second plurality of reel strip sets may contain reel strips sets having a higher hit rate frequency when compared to the reel strip sets from the first plurality of reel strip sets. In one implementation, the hit rate frequency of a second plurality of reel strip sets may be 50%. A hit rate frequency of 50% means that over many plays of a game utilizing the reel strip sets contained in the second plurality of reel strip sets, an average of fifty out of every one hundred plays of the game will generate a winning outcome. Scaled for illustration, a hit rate frequency of 50% may be represented as ten winning outcomes or wins 830 and ten non-winning outcomes 840 distributed along timeline 815. Viewed in this manner, it can be appreciated that the system could follow every non-winning outcome with a winning outcome. Further, in this implementation, only a very small series of like outcomes would likely ever be generated and no anticipation for a winning outcome would develop as players would recognize that winning outcomes happen often. The frequent nature of winning outcomes may not be satisfactory to players.

FIG. 8C illustrates the group or cluster effect on the timing of winning outcome of a gaming system utilizing reel strip sets (e.g., symbol sets) with different hit rate frequencies for variable win frequency gaming as described for one implementation of the disclosure. The gaming system of FIG. 8C initially selects reel strip sets from a first plurality of reel strip sets having a low hit rate frequency, as illustrated in FIG. 8A. As is illustrated in timeline 825 of FIG. 8C, using reel strip sets from the first plurality of reel strip sets provides a lower probability that a winning outcome will be generated and a higher probability that a series of non-winning outcomes will be generated. A series of non-winning outcomes 860 builds player anticipation that a winning outcome will be occurring soon. When a winning outcome is generated, the gaming system may vary the reel strip set selection and select a reel strip set from a second plurality of reel strip sets having a higher hit rate frequency than the reel strip sets from the first plurality of reel strip sets. Continuously using reel strip sets from the second plurality of reel strip sets in sequential plays of a game provides a high probability that a winning outcome will be followed by one or more winning outcomes. This aspect is illustrated by winning outcome series 850. As long as a winning outcome is generated, the gaming system may continue to select the reel strip set from the second plurality of reel strip sets having a high hit rate frequency. In this manner, a series of winning outcomes 850 may be generated and may provide great excitement to a player.

It should be appreciated that the likelihood of obtaining different quantities of winning outcomes can be varied in different implementations. For example, in one implementation, the gaming system may generate game outcomes from a reel strip set selected from the first plurality of reel strip sets for a first predetermined number of games. The gaming system may then generate game outcomes from reel strip sets selected from the second plurality of reel strip sets for a second predetermined number of games. The first predetermined number of games and the second predetermined number of games may be the same or different. In one implementation, when a winning outcome triggers a selection of a reel strip set from a second plurality of reel strip sets, the gaming system may continue to select reel strip sets from the second plurality of reel strip sets for a predetermined number of games regardless of game outcome. Other variations are possible.

In the above described implementations, reel strip sets are selected from a plurality of reel strip sets when a wager for a next play of the game is entered into the gaming system. In other implementations, the reel strip sets may be selected at any other appropriate time. For example, the next reel strip set may be selected by the processor of the gaming system immediately after the evaluation, by the processor of the gaming system, of winning symbol combinations in block 655 of FIG. 6B.

It should be appreciated that the first plurality of reel strip sets having a low hit rate frequency value of 10% and the second plurality of reel strip sets having a high hit rate frequency value of 50% are for illustration of the principles of the varying reel strips for variable win frequency gaming system. In other implementations, the first plurality of reel strip sets having a low hit rate frequency may be lesser or greater than 10% and the second plurality of reel strip sets having a high hit rate frequency value may be lesser or greater than 50%. A wide variety of reel strip sets having a wide variety of hit rate frequencies are contemplated.

In one implementation, the gaming system and method utilizes reel strip sets selected such that the overall RTP amount for any particular gaming system remains constant, or substantially constant (e.g., within a designated predetermined range of return to player amounts) during a plurality of plays of a game. It should be appreciated that the number of sets of reel strip sets utilized by the system may be varied to generate a constant or substantially constant overall RTP amount. In a like manner, it should be appreciated that the symbol sets contained within each reel strip set may be varied to generate desired RTP values.

In some implementations, the gaming system and method having varying reel strips for variable win frequency gaming described herein may be implemented as a base game on a gaming system. In other implementations, the gaming system and method having varying reel strips for variable win frequency gaming described herein may be implemented in a base game for an additional wager. In yet other implementations, the gaming system and method having varying reel strips for variable win frequency gaming described herein may be implemented in a bonus game not associated with a wager. In yet other implementations, the gaming system and method having varying reel strips for variable win frequency gaming described herein may be implemented as a bonus game feature requiring a wager or an additional wager. In yet other implementations, the gaming system and method having varying reel strips for variable win frequency gaming described herein may be a feature in both a base game and a bonus game, either with or without additional wagers.

In some implementations, the gaming system pay tables may be the same across all reel strip sets. Alternatively, in some implementations, the pay tables may vary dependent upon the reel strip set selected from the plurality of reel strip sets in any particular game. In some implementations, the gaming system may vary the pay tables dependent upon the reel strip set selected by associating a multiplier value (e.g., 2×, 3×, or other suitable multiplier value) with one or more reel strip sets of the plurality of reel strip sets. For example, in some implementations, one or more of the reel strips sets of the plurality of reel strip sets may be associated with a 2× multiplier value. When the gaming system selects a reel strip set from the plurality of reel strip sets associated with the 2× multiplier value, and a play of the game generates a symbol combination associated with an award as indicated by the pay table, the gaming system may multiply a value of the award associated with the symbol combination indicated by the pay table by a factor of two. That is, when the gaming system generates a symbol combination using a reel strip set associated with a 2× multiplier and the pay table associates an award value of ten credits with the generated symbol combination, the gaming system will award twenty credits (e.g., 2×10). Thus, in one play of a game, in some implementations, the gaming system may generate a “fruit-fruit-fruit” symbol combination that results in an award of 10 credits. In a subsequent play of a game, the gaming system may generate the same “fruit-fruit-fruit” symbol combination that results in an award of 20 credits because the selected reel strip set utilized in the subsequent play of the game was associated with a 2× multiplier. In this manner, the gaming system effectively varies the pay table because the pay table award value associated with symbol combination outcomes generated during use of a particular reel strip set will be multiplied by the associated multiplier value. Thus, the pay table award value associated with certain symbol combinations will vary based upon the multiplier value associated with the selected reel strip set, and a player's satisfaction with the gaming system is further enhanced.

As noted hereinabove in the discussion of FIG. 6, in some implementations, the gaming system may select a reel strip set from a plurality of reel strip sets based upon a prior game outcome. In some implementations, the gaming system may select a reel strip set from a plurality of reel strip sets having a high probability of generating a winning outcome when the prior game outcome is a winning outcome, thereby enhancing the probability that the gaming system may generate two, three, or more consecutive winning outcomes. In this manner, the gaming system may create a winning streak or a “hot” status. Player excitement and anticipation for the gaming system entering a winning streak or a “hot” status producing winning outcomes is greatly enhanced by the aspects and features described herein.

Additional implementations of the aspects described herein allow the gaming system to create additional gaming system statuses. In some implementations, the gaming system may create an “extended hot” status as will be described hereinbelow. In some implementations, the gaming system may create a “win by” status, also described hereinbelow. Previous implementations of the gaming system as described in FIGS. 6A, 6B (e.g., the “hot” status) and additional implementations of the gaming system (e.g., the “extended hot” status and the “win by” status) may be best understood by a consideration of gaming system behavior over an operational period via an operational or state diagram.

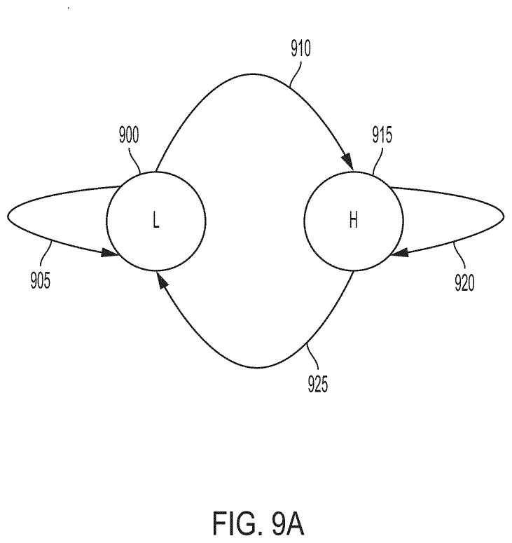

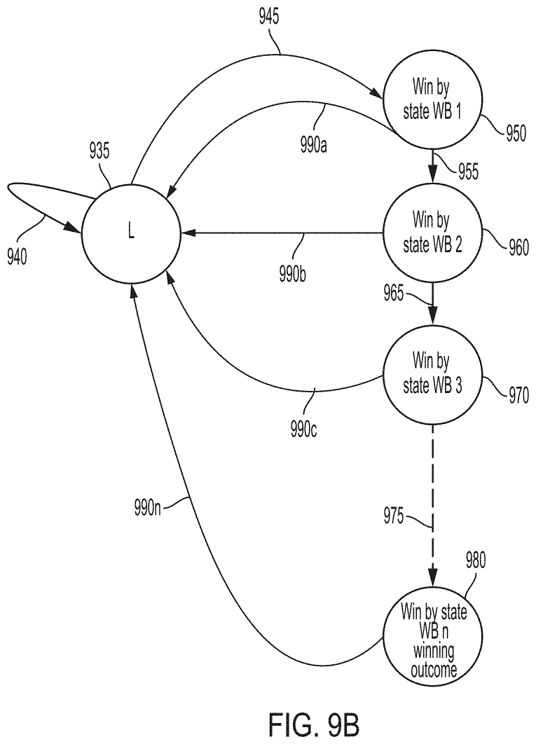

FIG. 9A shows an example state diagram illustrating gaming system behavior as the gaming system executes the operational flow of FIGS. 6A and 6B including variable reel strip sets for variable win frequency gaming. As illustrated in FIG. 9A, in some implementations, the gaming system may operate in an L state 900, where the gaming system selects a reel strip set from a plurality of reel strip sets having a low probability of producing a winning outcome, or in an H state 915, where the gaming system selects a reel strip set from a plurality of reel strip sets having a high probability of producing a winning outcome. Connection arrow 905 indicates gaming system behavior when a play of the game utilizing reel strips sets having a low probability of producing a winning outcome results in a non-winning outcome. That is, the gaming system remains in L state 900 and continues to utilize reel strip sets having a low probability of producing a winning outcome. The L state of FIG. 9A corresponds to operational flow steps 615, 620, 625, 630, and 640-665 of FIGS. 6A-6B in some implementations.

In some implementations, the gaming system continues operation in L state 900 and continues selecting reel strip sets having a low probability of producing a winning outcome, (e.g., reel strips having a 10% chance of producing a winning outcome as described hereinabove or some other suitable percentage) until a winning outcome is achieved. Upon the occurrence of a winning outcome, gaming system behavior changes to operation in H state 915, as indicated by connection arrow 910. The H state 915 of FIG. 9A, in some implementations, corresponds to operational flow steps 615, 620, 625, 635, and 640-665 of FIGS. 6A-B. As described hereinabove, the gaming system operating in H state 915 selects reel strips having a high probability of producing a winning outcome, relative to the reel strip sets that the gaming system selects when operating in L state 900. As described hereinabove, the gaming system continues to select reel strip sets having a high probability of producing a winning outcome, (e.g., reel strips having a 50% chance of producing a winning outcome or some other suitable percentage) via loop 920 as long as winning outcomes are achieved. The gaming system will transition back to L state 900 via connection arrow 925 when a non-winning outcome is achieved.

In some implementations, the gaming system may utilize varying reels strip sets as described herein to create an “extended hot” status. In such implementations, operational flow as illustrated in FIG. 6A may proceed directly from block 620 to block 635 for a number of plays of the game. That is, once an “extended hot” status is entered, the gaming system may, in some implementations, continue selecting reel strip sets from a plurality of reel strip sets having a high probability of producing a winning outcome based upon a determined number of plays of the game rather than based upon the outcome status of the previous game in the “hot” status. In this manner, the gaming system may continue randomly selecting game symbols from the previously selected reel strip set (e.g., a reel strip set having a high probability of producing a winning outcome), for a number of additional plays of the game, thereby “extending” the “hot” status regardless of whether the last game played resulted in a winning outcome. It should be appreciated that in some implementations, the gaming system does not continue using the previously selected reel strip set and may select an alternative reel strip set as long as the selected reel strip set has a high probability of generating a winning outcome. It should be appreciated that, in some implementations, the number of games played during an “extended hot” status may include games that do not result in a winning outcome. In this manner, the “extended hot” status is distinct from the “hot” status which, as illustrated in FIG. 6A, terminates when the last game played does not result in a winning outcome.

In some implementations, the gaming system may determine the number of “extended hot” status plays of the game and the gaming system may operationally track the number by a counter value that is decremented (e.g., from “number” to “zero” or any suitable threshold number) each time a game is played in the “extended hot” status. In this manner, the gaming system may utilize the counter value to determine the number of times operation 600 may flow from block 620 to block 635 before returning to operation including decision block 625. Considering the state diagram of FIG. 9A, direction arrow 920 represents gaming system behavior when the gaming system continues operation in H state 925, both when the gaming system remains in H state 925 due to continued winning outcomes (e.g., a “hot status) as described hereinabove, and when the gaming system has entered an “extended hot” status where the gaming system is executing a number of plays of the game in H state 925 without regard to the immediately prior game outcome. In this manner, the gaming system may return to H state 925 via direction arrow 920 a number of times until the counter value is zero or some other suitable threshold number for the extended “hot” status. It should be appreciated that in some implementations, the counter value may increment (e.g., from “zero” to “number” or any suitable threshold number) each time a game is played in the “extended hot” status. It should further be appreciated that the gaming system may determine the number of “extended hot” status plays in any suitable manner (e.g., the number of plays may be predetermined, randomly generated, based upon length of play time, or other suitable manner). It should further be appreciated that after conclusion of play of an “extended hot” status, the gaming system may reset the counter value and determine a new number for subsequent “extended hot” status play.

In some implementations, the gaming system and method having varying hit rate frequency reel strips (e.g., varying symbol sets) for variable win frequency gaming described herein may include a signifier to alert the player that the reel strip has been altered and the game is functioning in a “hot” status or in an “extended hot” status, as described above. The signifier may be a visual signifier, an audio signifier, or any combination of both visual and audio signifiers. In some implementations, the gaming system may include visual signifier(s) on one or more of the display devices of the gaming system. In some implementations the gaming system may indicate a change of state from L state 900 to H state 915 by altering screen 300 in any suitable manner to indicate the change of game state (e.g., symbol colors may be altered or enhanced, symbol background colors may be altered or enhanced, visual borders may be added to surround symbols, surround symbol positions, surround the reels, surround screen 300, etc.). In some implementations, the signifier may be an audio signifier. In some implementations, the signifier may audibly communicate that the gaming system has entered a “hot” status or that the gaming system will be in a “hot” status for the next (determined) number of plays of the game. In some implementations, the gaming system may audibly communicate the different hit rate frequency values or range of values utilized by the gaming system. In some implementations, the signifier may communicate the hit rate value of the reel strip selected from a plurality of reel strips for a play of a game on the gaming system. In some implementations, the gaming system audio may be altered, or audio volume may increase. It should be appreciated that the gaming system may utilize any suitable combination of visual or audio signifiers to notify players that game play has entered play in H state 915 to enhance player anticipation and excitement.

Turning now to FIG. 9B, in some implementations, after a non-winning outcome, the gaming system may trigger or initiate a “win by” status of game play. As used herein, a “win by” status means the gaming system will trigger a winning outcome within a determined quantity of next plays of the game. In some implementations, the gaming system may trigger the “win by” status after a prolonged consecutive number of non-winning outcomes. In some implementations, the gaming system may trigger the “win by” status after a predetermined quantity of plays of the game. In some implementations, the gaming system may trigger the “win by” status at random. It should be appreciated that the gaming system may trigger the “win by” status in any suitable manner.

In some implementations, the gaming system may have a defined quantity of next plays of the game associated with the “win by” status. For example, the gaming system may associate the quantity 10 with the “win by” status whereby the gaming system will generate a winning outcome within the next 10 plays of the game. That is, in this example the gaming system may generate a winning outcome on any one of the next 9 plays of the game and will generate a winning outcome on the 10^{th} play of the game if a winning outcome is not achieved during the prior 9 plays of the game. In some implementations, the gaming system may randomly select a quantity of next plays of the game to be associated with the “win by” status. In some implementations, the gaming system may select or determine the defined quantity of next plays of the game to be associated with the “win by” status in any suitable manner.

In FIG. 9B, the gaming system may be operating in L state 935 and selects a reel strip set from a plurality of reel strip sets having a low probability of producing a winning outcome as described hereinabove. Connection arrow 940 indicates gaming system behavior when a play of the game utilizing a reel strip set having a low probability of producing a winning outcome results in a non-winning outcome. That is, the gaming system remains in L state 935 and continues to select a reel strip set from a plurality of reel strip sets having a low probability of producing a winning outcome. The L state of FIG. 9B corresponds to operational flow steps 615, 620, 625, 630, and 640-665 of FIGS. 6A-B. In some implementations, once the gaming system has triggered the “win by” status and determined the quantity of next plays of the game within which a winning outcome is to be generated, the gaming system transitions to operation in WB1 state 950 via direction arrow 945. In WB1 state 950, the gaming system will select a reel strip set from a plurality of reel strip sets having a high probability of generating a winning outcome even though the immediately prior gaming system outcome was a non-winning outcome. In some implementations, this change in operation flow is a result of gaming system entering the “win by” status and corresponds to a non-winning outcome of decisional block 652 flowing to block 635 in FIG. 6A rather than to block 630, as indicated. By selecting a reel strip set from a plurality of reel strip sets having a high hit rate frequency, the gaming system increases the probability that the next play of the game will result in a winning outcome. When the next play of the game (e.g., a game played in the WB1 state) results in a winning outcome, the gaming system may return to operating in L state 935 as indicated via directional arrow 990a. When the next play of the game (e.g., a game played in the WB1 state) results in a non-winning outcome, the gaming system continues operation in the “win-by” status and the gaming system operation moves to WB2 state 960.

In some implementations, in WB2 state 960, the gaming system will select a reel strip set from a plurality of reel strip sets having a greater probability of generating a winning outcome than the reel strip set selected and utilized in WB1 state 950. By selecting a reel strip set from a plurality of reel strip sets having a greater probability of generating a winning outcome, the gaming system further increases the probability that a winning outcome will be produced in some implementations. In some implementations, this change in operation flow is a result of gaming system entering the “win by” status and corresponds to a non-winning outcome of decisional block 652 flowing to block 635 in FIG. 6A rather than to block 630, as indicated. By selecting a reel strip set from a plurality of reel strip sets having a greater probability of generating a winning outcome, the gaming system further increases the probability that the next play of the game will result in a winning outcome. When a next play of the game (e.g., a game played in the WB2 state) results in a winning outcome, the gaming system may return operating in L state 935 as indicated via directional arrow 990b in some implementations. When the next play of the game (e.g., a game played in the WB2 state) results in a non-winning outcome, the gaming system continues operation in the “win-by” status and the gaming system operation moves to WB3 state 970.

In WB3 state 970, the gaming system will select a reel strip set from a plurality of reel strip set having yet an even greater probability of generating a winning outcome than the reel strip set selected and utilized in WB2 state 960. By selecting a reel strip set from a plurality of reel strip sets having a greater probability of generating a winning outcome, the gaming system yet further increases the probability that a winning outcome will be produced. In some implementations, this change in operation flow is a result of gaming system entering the “win by” status and corresponds to a non-winning outcome of decisional block 625 flowing to block 635 in FIG. 6A rather than to block 630, as indicated. By selecting a reel strip set from a plurality of reel strip sets having yet an even higher probability of generating a winning outcome, the gaming system further increases the probability that the next play of the game will result in a winning outcome. When a next play of the game (e.g., a game played in the WB3 state 970) results in a winning outcome, the gaming system may return operating in L state 935 as indicated via directional arrow 990c. When the next play of the game (e.g., a game played in the WB3 state 970) results in a non-winning outcome, the gaming system continues operation in the “win-by” status and the gaming system operation continues selecting a reel strip set from a plurality of reel strip sets having incrementally greater probabilities of generating a winning outcome and executing additional plays of the game (as indicated by dashed directional arrow 975) until the desired winning outcome is achieved, illustrated as WBn state 980. It should be appreciated that the greater probabilities can be something other than incremental in some implementations, as is discussed below. In some implementations, when a next play of the game (e.g., a game played in the WBn state 980) results in a winning outcome, the gaming system may return operating in L state 935 as indicated via directional arrow 990n and the gaming system concludes operation in the “win by” status.

Returning to FIG. 5, in some implementations, the probability of generating a winning outcome (e.g., the hit rate frequency) of a reel strip set illustrated as in FIG. 5 may be calculated as the total number of possible winning outcomes divided by the total number of possible symbol combinations. Thus, by creating reel strip sets having reel strips with increasing numbers of symbols that may generate a winning outcome, increased hit rate frequencies may be achieved. For example, reel strip 570 contains 15 symbol positions with 10 symbol positions containing winning outcome generating symbols, reel strips 580 and 590 each contains 13 symbol positions with winning outcome generating symbols. Thus, the total number of possible winning outcomes is 10×13×13, or 1690, and the total number of possible symbol combinations is 15×15×15, or 3375. The hit rate frequency in the example is 1690/3375 or 0.5007 or 50.07%. By increasing the number of winning symbols on reel strip 570 to 11, the hit rate frequency of the reel strip set becomes 11×13×13 or 1859 and the total number of possible symbol combinations remains 3375 and the hit rate frequency may be calculated as 1859/3375 0.5508 or 55.8%. Similarly, in the example, by increasing the number of winning symbols on reel strip 570 to 13, the hit rate frequency becomes 2197/3375 or 0.6509 or 65.09%. As can be appreciated, reel strips and reel strip sets can be generated having known and controlled hit rate frequencies up to and including a reel strip set having a 100% hit rate frequency (e.g., a reel strip set having reel strips containing only winning outcome generating symbols).

Returning to the example of a gaming system associating the quantity 10 with the “win by” status whereby the gaming system will generate a winning outcome within the next 10 plays of the game, the gaming system WBn state 980 is represented as WB10. In some implementations, L state 935 may cause the gaming system to select a reel strip set from a plurality of reel strip sets having a low probability of generating a winning outcome (e.g., 10%) when the “win by” status is triggered. Thus, the gaming system may select reel strip sets from pluralities of reel strip sets having hit rate probabilities >10% and <100% for states WB1-WB9, and the gaming system may reserve selection of a reel strip sets having a hit rate frequency or probability of 100% for state WB10. In this manner, the gaming system can trigger a winning outcome within a determined quantity of next plays of the game. It should be appreciated that the gaming system may select a reel strip set from a plurality of reel strip sets having hit rate probabilities >10% and <100% for states WB1-WB9 in a sequentially increasing manner (e.g., 40%, 50%, 60%, 65%, 70% [ . . . ] with WB10 being 100%) or in a selectively random manner (e.g., 65%, 48%, 75%, 90%, 25%, [ . . . ] with WB10 being 100%), or the gaming system ay select a reel strip set from a plurality of reel strip sets in any suitable manner.

It should further be appreciated that in some implementations, the gaming system and method having varying hit rate frequency reel strips (e.g., varying symbol sets) for variable win frequency gaming described herein may include a signifier to alert the player that the game is functioning in a “win by” status in the same manner as described above with respect to the “hot” status and the “extended hot” status. That is, the signifier may be a visual signifier, an audio signifier, or any combination of both visual and audio signifiers, and communicates to the player that the gaming system has entered a “win by” status of play and, in some implementations, the signifier may communicate the quantity of next plays of the game within which the gaming system will trigger a winning outcome. In some implementations, a signifier for a “win by,” “hot,” and “extended hot” statuses can be different from each other. In some implementations, the signifiers can be the same for one or more of the different statuses.

The present disclosure is not to be limited in terms of the particular implementations described in this application, which are intended as illustrations of various aspects. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations of the invention have been described. Various modifications may be made without departing from the spirit and scope of the invention. For example, various forms of the flows shown above may be used, with steps re-ordered, added, or removed. Accordingly, other implementations are within the scope of the following claims.

We claim:

1. A gaming system comprising:
a display device, an input device, a value acceptor, a value dispenser, a random number generator, a memory device, and a processor, wherein the memory device stores program instructions that, when executed by the processor, cause the processor to:
establish a credit balance based on a value received by the value acceptor;
receive, via the input device, a wager for a play of a game using the credit balance;
determine an operating status of the gaming system;
select symbols sets based upon the operating status;
display, using the display device, a symbol display area including a plurality of randomly generated symbols from the selected symbol sets;
evaluate the plurality of randomly generated symbols for predetermined symbol combinations;
determine one or more awards based upon the plurality of randomly generated symbols corresponding to the one or more predetermined symbol combinations; and
issue a monetary value from the value dispenser based on the one or more awards upon receipt of a cash out request.

2. The gaming system of claim 1, wherein the operating status causes the gaming system to operate with a high probability of generating winning outcomes.

3. The gaming system of claim 2, wherein the operating status causes the processor to select a symbol set from a plurality of symbol sets having a high probability of generating a winning outcome.

4. The gaming system of claim 3, wherein the plurality of symbol sets have a probability of generating a winning outcome that is greater than 50 percent.

5. The gaming system of claim 2, wherein the operating status causes the gaming system to continue to operate with a high probability of generating winning outcomes until a predetermined number of plays of the game have been executed.

6. The gaming system of claim 1, wherein the operating status causes the gaming system to generate a winning outcome within a determined number of plays of the game.

7. The gaming system of claim 6, wherein the determined number of plays of the game is predetermined.

8. The gaming system of claim 6, wherein the determined number of plays of the game is randomly determined.

9. The gaming system of claim 6, wherein the operating status further comprises causing the processor to select a symbol set from a plurality of symbol sets having a high probability of generating a winning outcome.

10. The gaming system of claim 9, wherein when the generated outcome is not a winning outcome, the operating status causes the processor to select a symbol set having a higher probability of generating a winning outcome than the previously selected symbol set.

11. A method of operating a gaming system, the method comprising:
establishing a credit balance based on a value received by a value acceptor;
receiving, via an input device, a wager for a play of a game using the credit balance;
determining, by a processor, an operating status of the gaming system;
selecting symbols sets, by the processor, based upon the operating status;
displaying, using a display device, a symbol display area including a plurality of randomly generated symbols from the selected symbol sets;
evaluating, by the processor, the plurality of randomly generated symbols for predetermined symbol combinations;
determining, by the processor, one or more awards based upon the plurality of randomly generated symbols corresponding to the one or more predetermined symbol combinations; and
issuing a monetary value from a value dispenser based on the one or more awards upon receipt of a cash out request.

12. The method of operating a gaming system of claim 11, wherein the operating status causes the gaming system to operate with a high probability of generating winning outcomes.

13. The method of operating a gaming system of claim 12, wherein the operating status causes the processor to select a symbol set from a plurality of symbol sets having a high probability of generating a winning outcome.

14. The method of operating a gaming system of claim 13, wherein the plurality of symbol sets have a probability of generating a winning outcome that is greater than 50 percent.

15. The method of operating a gaming system of claim 12, wherein the operating status causes the gaming system to continue operating with a high probability of generating winning outcomes until a predetermined number of plays of the game have been executed.

16. The method of operating a gaming system of claim 11, wherein the operating status causes the gaming system to generate a winning outcome within a determined number of plays of the game.

17. The method of operating a gaming system of claim 16, wherein the determined number of plays of the game is predetermined.

18. The method of operating a gaming system of claim 16, wherein the determined number of plays of the game is randomly determined.

19. The method of operating a gaming system of claim 16, wherein the operating status further comprise causing the processor to select a symbol set from a plurality of symbol sets having a high probability of generating a winning outcome.

20. A non-transitory computer readable medium having machine instructions stored thereon, the machine instructions being executable by a processor causing a processor to:
establish a credit balance based on a value received by a value acceptor;
receive, via an input device, a wager for a play of a game using the credit balance;
determine, via a processor, an operating status of the gaming system;
select symbols sets, via the processor, based upon the operating status;
display, using a display device, a symbol display area including a plurality of randomly generated symbols from the selected symbol sets;
evaluate, via the processor, the plurality of randomly generated symbols for predetermined symbol combinations;
determine, via the processor, one or more awards based upon the plurality of randomly generated symbols corresponding to the one or more predetermined symbol combinations; and
issue a monetary value from a value dispenser based on the one or more awards upon receipt of a cash out request.
